(19) United States
(12) Patent Application Publication
(10) Pub. No.: US 2016/0006688 A1
(43) Pub. Date: Jan. 7, 2016

(54) COMMUNICATION-CHANNEL CONTROL DEVICE, ADDRESS CONVERSION DEVICE, COMMUNICATION SYSTEM, AND COMMUNICATION-CHANNEL SETTING METHOD

(71) Applicant: FUJITSU LIMITED, Kawasaki-shi (JP)

(72) Inventor: Naotoshi WATANABE, Yokohama (JP)

(21) Appl. No.: 14/854,507

(22) Filed: Sep. 15, 2015

Related U.S. Application Data
(63) Continuation of application No. PCT/JP2013/057638, filed on Mar. 18, 2013.

(51) Int. Cl. H04L 29/12; H04W 72/04

(52) U.S. Cl. CPC H04L 61/25; H04W 72/0406

(57) ABSTRACT

A setting storage unit and an address conversion device selection unit, the setting storage unit stores combinations of first and second communication channels. A plurality of said first communication channels are set up between the following: a plurality of first node devices that connect a first network, in which a base station device is provided, to a second network and a plurality of address conversion devices in the second network. A plurality of the second communication channels are set up between the following: a plurality of second node devices that connect a third network to the second network and the plurality of address conversion devices. The address conversion device selection unit selects one of the address-conversion devices, each of which acts as a relay between one of the first and second node devices via one of the first communication channels and one of the second communication channels.

### CROSS-REFERENCE TO RELATED APPLICATION

This application is a continuation application based on International Application PCT/JP 2013/057638, filed on Mar. 18, 2013, the contents being incorporated herein by reference.

### FIELD

The embodiments discussed herein relate to a communication-channel (hereinafter “channel”) control device, address conversion device, communication system, and communication-channel (hereinafter “channel”) setting method.

### BACKGROUND

A mobile communication system is provided with a mobile communication network which routes a mobile station device and an external network. Such a mobile communication network includes, for example, a wireless access network which includes a mobile station device and base station device and a core network which connects the wireless access network with the external network. When a mobile station device communicates with an opposing communication device through the external network, one node device of the mobile communication network acts as an anchor point. A channel is provided between the node device of the anchor point and the mobile station device. The mobile station device is allocated an address to be used on the external network.

As related art, there is known a system in which a plurality of local networks are connected through a router with an NAPT (Network Address Port Translation) function to a trunk network and in which a first terminal, which is connected to a first local network, communicates with a second terminal through the first router and trunk network (for example, see PLT 1).

Further, there is known a gateway which is arranged in a mobile core network and performs NAPT processing. The gateway transfers a packet, which has a specific sending/receiving address and sending/receiving port number, to a packet transfer apparatus which is arranged downstream of the gateway and performs NAPT processing when that packet arrives at the gateway. The packet transfer apparatus transfers the packet, which it receives from the gateway, as a packet having a desired sending/receiving address and sending/receiving port number (for example, see PLT 2).

### RELATED ART

### Patent Literature

### PLT 1: Japanese Laid-Open Patent Publication No. 2008-219490

### PLT 2: Japanese Laid-Open Publication No. 2008-166874

After a certain node device is set as an anchor point, sometimes a channel, which is routed through a node device other than this node device, becomes more suitable than a channel which is routed through this node device. For example, sometimes, due to movement of a mobile station device, the distance on the network between the node device which is set as the anchor point and the mobile station device becomes larger, and therefore routing through another node device would shorten the channel.

In such a case, if newly setting a channel between the mobile station device and the node device, channel setting processing and address allocation processing would be incurred and the load on the node device would increase.

### SUMMARY

According to one aspect of an apparatus, a channel control device is provided. The channel control device comprises a setting storage unit which stores settings for combining a plurality of first channels and a plurality of second channels, where the first channels are set between a plurality of first node devices and a plurality of address conversion devices of a second network, first node devices connect a first network in which a base station device is provided, to the second network, and the plurality of second channels are set between a plurality of second node devices and the plurality of address conversion devices, the second node devices connect a third network, different from the first network and the second network, to the second network; and

an address conversion device selection unit which selects any of the plurality of address conversion devices, where the address conversion devices act as a relay between any of the plurality of first node devices and any of the plurality of second node devices routed through any of the plurality of first channels and any of the plurality of second channels.

According to another aspect of an apparatus, an address conversion device is provided. The address conversion device comprises a transfer unit which transfers packets between a plurality of first channels and a plurality of second channels, the first channel are preset between a plurality of first node devices and the address conversion device, the first node devices connect a first network, in which a base station device is provided, to a second network in which the address conversion devices are provided, and the plurality of second channels are set between a plurality of second node devices and the plurality of address conversion devices, the second node devices connect a third network, different from the first network and the second network, to the second network;

a conversion information storage unit which stores, for each of the plurality of first channels, conversion information which links a first address of a mobile station device and a second address on the third network, the mobile station device transmits packets through the plurality of first channels;

a detection unit which detects an entry of a source address from the conversion information of the first channel, other than the any channel, when there is no entry of said source address of packets, which are received through any channel among the plurality of first channels, in the conversion information of that any channel, where said first channel receive packets which are transferred from any of the plurality of second node devices which transmit packets transferred to that any channel; and

a conversion information update unit which moves the detected entry to the conversion information of that any channel.

### BRIEF DESCRIPTION OF DRAWINGS

FIG. 1 is an explanatory view of a first example of the configuration of a communication system.

FIG. 2 is a view of the functional configuration of one example of a S-GW (serving gateway).

FIG. 3 is an explanatory view of one example of a first channel setting table.

FIG. 4 is an explanatory view of one example of a first relay table.

FIG. 5 is an explanatory view of one example of a branched flow processing table.

FIG. 6 is an explanatory view of one example of an integrated flow processing table.

FIG. 7 is an explanatory view of one example of a destination designation table.

FIG. 8 is an explanatory view of one example of an address conversion device table.

FIG. 9 is a view of the functional configuration of one example of a channel control device.

FIG. 10 is an explanatory view of a first example of a second channel setting table.

FIG. 11 is a view of the functional configuration of one example of an address conversion device.

FIG. 12 is an explanatory view of one example of an address conversion table.

FIG. 13 is an explanatory view of one example of a second relay table.

FIG. 14 is an explanatory view of one example of a resource management table.

FIG. 15 is a view of the functional configuration of one example of a P-GW (Packet Data Network Gateway).

FIG. 16 is an explanatory view of one example of a downlink transfer table.

FIG. 17 is an explanatory view of one example of an uplink transfer table.

FIG. 18 is an explanatory view of one example of a third channel setting table.

FIG. 19 is an explanatory view of one example of an MME (Mobility Management Entity).

FIG. 20 is an explanatory view of one example of an address conversion device route flow table.

FIG. 21 is an explanatory view of one example of a new channel setting operation (part 1).

FIG. 22 is an explanatory view of the new channel setting operation (part 2).

FIG. 23 is an explanatory view of one example of a new channel setting operation in an S-GW.

FIG. 24 is an explanatory view of a modification of a new channel setting operation at an S-GW.

FIG. 25 is an explanatory view of one example of a new channel setting operation in a channel control device.

FIG. 26 is an explanatory view of one example of an operation of a S-GW when receiving uplink packets.

FIG. 27 is an explanatory view of one example of an operation of a S-GW when receiving downlink packets.

FIG. 28 is an explanatory view of a first example of an operation of an address conversion device when receiving uplink packets.

FIG. 29 is an explanatory view of one example of an operation of an address conversion device when receiving downlink packets.

FIG. 30 is an explanatory view of a first example of a channel changing operation.

FIG. 31 is an explanatory view of one example of an operation of an MME at the time of handover.

FIG. 32 is an explanatory view of a first example of an operation of an S-GW at the time of handover.

FIG. 33 is an explanatory view of a second example of an operation of an address conversion device when receiving uplink packets.

FIG. 34 is an explanatory view of a second example of a channel changing operation.

FIG. 35 is an explanatory view of one example of an operation of a S-GW in resource changing processing.

FIG. 36 is an explanatory view of a first example of an operation of a channel control device in resource changing processing.

FIG. 37 is an explanatory view of one example of an operation of an address conversion device in resource changing processing.

FIG. 38 is an explanatory view of a first example of an operation of a P-GW in resource changing processing.

FIG. 39 is an explanatory view of a second example of an operation of a P-GW in resource changing processing.

FIG. 40 is an explanatory view of a third example of a channel changing operation (part 1).

FIG. 41 is an explanatory view of a third example of the channel changing operation (part 2).

FIG. 42 is an explanatory view of a second example of a second channel setting table.

FIG. 43 is an explanatory view of one example of a first calculation method designation table.

FIG. 44 is an explanatory view of one example of a second calculation method designation table.

FIG. 45 is an explanatory view of a second example of an operation of a channel control device in resource changing processing.

FIG. 46 is an explanatory view of a second example of an operation of an address conversion device when receiving uplink packets.

FIG. 47 is an explanatory view of one example of the hardware configuration of an S-GW.

FIG. 48 is an explanatory view of one example of the hardware configuration of a channel control device.

FIG. 49 is an explanatory view of one example of the hardware configuration of an address conversion device.

FIG. 50 is an explanatory view of one example of the hardware configuration of a P-GW.

FIG. 51 is an explanatory view of one example of the hardware configuration of an MME.

FIG. 52 is an explanatory view of a second example of the configuration of a communication system.

### DESCRIPTION OF EMBODIMENTS

According to the apparatuses or methods which are disclosed in the present Description, the load on a node device is reduced when setting a channel for routing of a node device connecting a mobile communication network and external network.

### 1. Network Configuration

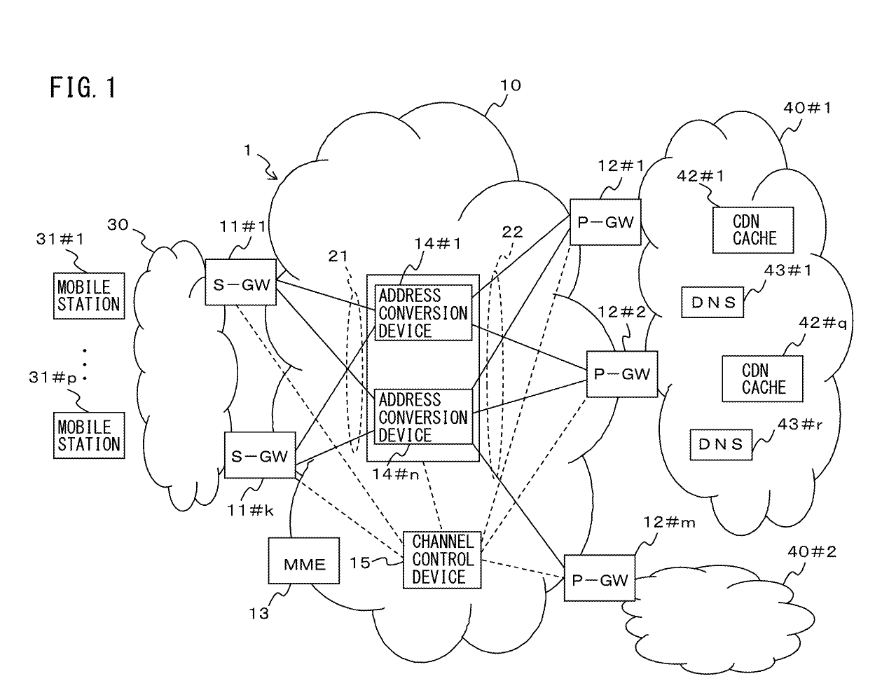

Below, preferred embodiments will be explained with reference to the attached drawings. FIG. 1 is an explanatory view of a first example of a configuration of a communication system. A communication system 1 is provided with a communication network 10 which connects a wireless access network 30 of a mobile communication system to an external network 40.

The communication network 10 is provided with S-GW apparatuses 11#1 to 11#k as node devices which connect the wireless access network 30 and the communication network 10. The communication network 10 is provided with P-GW apparatuses 12#1 to 12#m as node devices which connect the external networks 40#1, 40#2 . . . and communication network 10. The communication network 10 is provided with an MME 13 as a node device for bearer control between the mobile stations 31#1 to 31#p and P-GW apparatuses 12#1 to 12#m.

In the following explanation, use is made of the illustration of a case where the communication system 1 is a system based on the LTE (Long Term Evolution) prescribed in the standards of the 3GPP (3rd Generation Partnership Project). However, this illustration does not mean that the communication system which is described in the present Description is applied only to communication systems based on the LTE. The communication system which is described in the present Description can be broadly applied to systems which are provided with communication networks which connect wireless access networks to external networks.

Note that in the following explanation and attached drawings, a S-GW apparatus and a P-GW apparatus will sometimes be respectively indicated as an “S-GW” and a “P-GW”. Further, the S-GW's 11#1 to 11#k will sometimes be referred to all together as the “S-GW's 11”. Representative ones of the S-GW's 11#1 to 11#k will sometimes be indicated as the “S-GW 11#a” and “S-GW 11#b”. The P-GW's 12#1 to 12#m will sometimes be referred to all together as the “P-GW's 12”. Representative ones of the P-GW's 12#1 to 12#m will sometimes be indicated as the “P-GW 12#a” and “P-GW 12#b”. The external networks 40#1, 40#2 . . . will sometimes be referred to all together as the “external networks 40”.

The communication system 1 is comprised of a plurality of address conversion devices 14#1 to 14#n, a communication-channel (hereinafter “channel”) control device 15, a plurality of first communication-channels (hereinafter “channels”) 21, and a plurality of second channels (hereinafter “channels”) 22. In the following explanation, the address conversion devices 14#1 to 14#n will sometimes be referred to all together as the “address conversion devices 14”. Representative ones of the address conversion devices 14#1 to 14#n will sometimes be indicated as the “address conversion device 14#x” and “address conversion device 14#y”.

Further, the external network 40#1 includes CDN (Contents Delivery Network) cache servers 42#1, 42#2 . . . arranged distributed in it as examples of server apparatuses which are accessed by the mobile stations 31. The CDN cache servers 42#1, 42#2 . . . are server apparatuses which can provide the same contents. In the attached drawings, the CDN cache servers are indicated as “CDN caches”. Further, in the following explanation, the CDN cache servers 42#1, 42#2 . . . will be referred to all together as the “CDN cache servers 42”. The CDN cache servers 42#i and 42#j are CDN cache servers which represent the CDN cache servers 42#1, 42#2 . . . .

Further, the external network 40#1 is provided with DNS (Domain Name System) servers 43#1, 43#2 . . . which translate addresses of the CDN cache servers 42. In the following explanation and attached drawings, the DNS servers will be indicated as “DNS's”. Further, in the following explanation, the DNS's 43#1, 43#2 . . . will sometimes be referred to all together as the “DNS's 43”. The DNS's 43#i and 43#j are DNS's which represent the DNS's 43#1, 43#2 . . . .

Note that the CDN cache servers 42 and DNS's 43 may also be node devices of not only external networks 40 which are directly connected to the P-GW's 12, but also other external networks for routing through the external networks 40.

The address conversion devices 14 relay packets which are sent from the mobile stations 31 to the external networks 40 routed through the P-GW's 12. The address conversion devices 14 convert the source addresses of the packets, which are sent from the mobile stations 31, from the IP addresses and TCP/UDP port numbers which are used on the communication network 10 to IP addresses and TCP/UDP port numbers which are used on the external networks 40.

In the following explanation, the IP addresses and TCP/UDP port numbers will sometimes be simply indicated as “addresses”. Further, the addresses which are used on the communication network 10 will sometimes be indicated as “internal addresses”. The addresses which are used on the external networks 40 will sometimes be referred to as “external addresses”.

The address conversion devices 14 relay packets which are sent to the mobile stations 31 routed through the external networks 40 and the P-GWs 12. The address conversion devices 14 convert destination addresses of packets, which are sent from the mobile stations 31, from external addresses to internal addresses.

The plurality of first channels 21 are channels which are set in advance for the transfer of flows to access the CDN cache servers 42 by the mobile stations 31 and are provided between the S-GW's 11 and the address conversion devices 14. Further, the plurality of second channels 22 are channels which are set in advance for the transfer of flows to access the CDN cache servers 42 by the mobile stations 31 and are provided between the address conversion devices 14 and the P-GW's 12.

At the time of attachment of a mobile station 31, one of the P-GWs 12 is selected for routing the user packets of the mobile station 31. In the following explanation, the P-GW which is selected at the time of attachment of a mobile station 31 will be referred to as a “default P-GW”. The default P-GW, for example, may be the P-GW which is used fixedly for the mobile station 31 as an anchor point at the time of attachment of a mobile station 31. The path for transfer of the flow which a mobile station 31 sends and receives routed through the default P-GW will be referred to as the “default channel”.

The first channels 21 and second channels 22 may be comprised of VLAN paths which are identified by for example VLAN (Virtual Local Area Network)-IDs. Further, for example, the first channels 21 and the second channels 22 may, for example, be comprised of MPLS (Multi-Protocol Label Switching) label paths or IP capsulation paths.

The first channels 21 and the second channels 22 correspond to each other one to one. Different first channel 21 and second channel 22 are set for each combination of an S-GW 11, P-GW 12, and address conversion device 14. Further, when a single P-GW 12 has a plurality of external networks 40 connected to it, a combination of a first channel 21 and a second channel 22 is set for each external network 40.

That is, if the S-GW 11, P-GW 12, address conversion device 14, and external network 40, over which a flow for accessing a CDN cache server 42 by a mobile station 31 is transferred, are determined, one or more combinations of the first channel 21 and second channel 22 for transferring this flow are determined. The first channel 21 and second channel 22, other than the default channel, can be used to transfer a flow for accessing the CDN cache server 42 by a mobile station 31.

For each of the second channels 22, a region of external addresses is designated, which are used for the source addresses of the packets of the flow to be transferred by the second channel 22. When a mobile station 31 is allocated an external address, the address conversion device 14 designates an address within the region of external addresses which is designated for the second channel 22 corresponding to the first channel 21 which transfers an uplink flow from the mobile station 31 to the CDN cache server 42.

The P-GW 12 determines the second channel 22 for transferring the downlink flow from the CDN cache server 42 to the mobile station 31, based on the external address which is designated as the destination address. The flow, which is transferred by the second channel 22, is transferred to the address conversion device 14 where the destination address is converted to an internal address. The address conversion device 14 transfers the flow by the first channel 21 corresponding to the second channel 22, whereby a downlink flow from the CDN cache server 42 is transferred to the S-GW 11 which connects with the mobile station having an internal address to which an external address is allocated.

The channel control device 15 selects the address conversion device 14 for routing the flow by which the mobile station 31 accesses the CDN cache server 42, when the mobile station 31 accesses the CDN cache server 42. For example, the channel control device 15 may select the address conversion device 14 in accordance with a transfer delay between the S-GW 11, to which the mobile station 31 is connected, and the address conversion device 14. For example, the channel control device 15 may select the address conversion device 14 in accordance with the load or number of stored flows of the address conversion device 14.

When the address conversion device 14 is selected, the S-GW 11 connecting with the mobile station 31 selects a first channel 21 provided between the selected address conversion device 14 and the S-GW 11. The S-GW 11 separates the flow by which the mobile station 31 accesses the CDN cache server 42, among the uplink flows which flow from the mobile station 31 to the external network 40, from the flow of transfer by the default channel and transfers the result by the first channel 21. Further, the S-GW 11 integrates the downlink flow from the CDN cache server 42 receiving through the first channel 21 and the flow which flows through the default channel and then transmits the result to the mobile station 31.

### 2. Functional Configuration

Next, the functions of the individual component elements of the communication system 1 will be explained.

2.1. S-GW

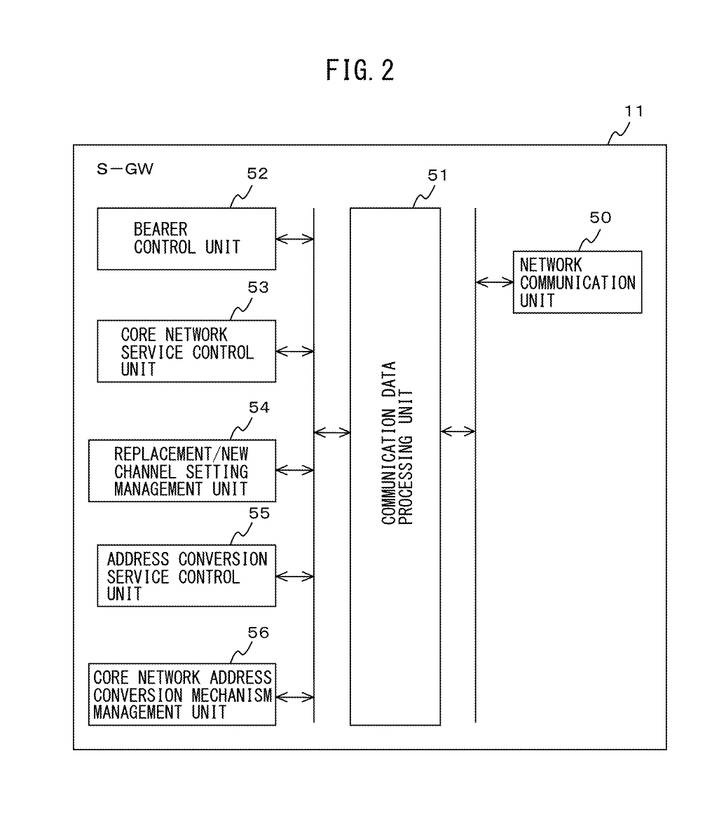

FIG. 2 is a view of the functional configuration of one example of an S-GW 11. The S-GW 11 is comprised of a network communication unit 50, communication data processing unit 51, bearer control unit 52, core network service control unit 53, and replacement/new communication-channel (hereinafter “channel”) setting management unit 54. The S-GW 11 is further comprised of an address conversion service control unit 55 and a core network address conversion mechanism management unit 56.

The network communication unit 50 terminates the communication protocols of the physical layer, data link layer, and network layer inherent to the communication network 10 and transfers data with other node devices of the communication network 10.

The communication data processing unit 51 performs routing the data and performs processing relating to the data transfer use protocol, based on the setting information of the channel (bearer). The communication data processing unit 51 recognizes wireless access procedure message such as signaling information addressed to the S-GW 11 and transfers data with other component elements in the S-GW 11 which process this signaling information.

The bearer control unit 52 sets, releases, and changes information transferred to the communication data processing unit 51, based on the information received from the core network service control unit 53, and holds and manages the setting information.

The core network service control unit 53 performs signaling processing for providing mobile communication services with a mobile station 31, another S-GW 11, the P-GW 12, and the MME 13.

The replacement/new channel setting management unit 54 receives a DNS request from a mobile station 31 inquiring about the address of the CDN cache server 42 and then performs processing for searching for a path between the S-GW 11 and a CDN cache server 42. The replacement/new channel setting management unit 54, for example, may search for a path routed through a P-GW other than the default P-GW 12.

To search for a new path other than the default channel, for example, the replacement/new channel setting management unit 54 makes the DNS request be transmitted to the communication data processing unit 51. The communication data processing unit 51 transmits the DNS request to another P-GW 12 in addition to the default channel.

In the following explanation, the case is assumed, where the mobile station 31 accessing the CDN cache server 42 is the mobile station 31#1. Further, the case is assumed, where the default P-GW of the mobile station 31#1 is the P-GW 12#a. The case is assumed, where the DNS response to the DNS request, which is transferred routed through the P-GW 12#a, designates the address of the CDN cache server 42#i.

Further, the case is assumed, where the P-GW 12, other than the default P-GW 12#a, to which the DNS request is transmitted is the P-GW 12#b and the DNS response to this DNS request designates the address of the CDN cache server 42#j.

The replacement/new channel setting management unit 54 determines that the CDN cache server 42#j routed through the P-GW 12#b is better than the CDN cache server 42#i routed through the default channel, when the DNS responses differ. In this case, the replacement/new channel setting management unit 54 decides to set a new channel for transfer of the flow to the CDN cache server 42#j routed through the first channel 21, second channel 22, and address conversion device 14.

In the following explanation, the flow by which the mobile station 31#1 accesses the CDN cache server 42#j will be referred to as the “additional flow”. Among additional flows, the flow from the mobile station 31#1 to the CDN cache server 42#j will be referred to as the “uplink additional flow”. Among additional flows, the flow from the CDN cache server 42#j to the mobile station 31#1 will be referred to as the “downlink additional flow”.

The replacement/new channel setting management unit 54 may start the routine between the MME 13 and the P-GW 12#b to set new channels for transfer of the additional flow other than the first channel 21 and second channel 22. Due to this routine, a new external address of the mobile station 31#1 is issued from the P-GW 12#b for the additional flow and a tunnel is formed between the S-GW 11 and the P-GW 12#b.

The address conversion service control unit 55 requests the channel control device 15 to transfer the additional flow routed through the first channel 21, second channel 22, and address conversion device 14. For this reason, the address conversion service control unit 55 transmits an “address conversion device route communication request” to the channel control device 15. The address conversion device route communication request may include identifiers of the S-GW 11, P-GW 12#b, and external network 40#1.

The address conversion service control unit 55 receives, from the channel control device 15, a request acknowledgement response to the address conversion device route communication request. The request acknowledgement response may include information which designates the address conversion device 14 which transfers the additional flow.

If the address conversion device 14 is provided with a plurality of communication ports, the destinations to be connected to the first channel 21 and the second channel 22 may be identified for each port. In this case, as the identifier for identifying the address conversion device 14, for example, an “address conversion device identifier” may be used, which shows a combination of the serial number of the address conversion device 14 and the communication port number for each device. The request acknowledgement response may include an address conversion device identifier as information designating the address conversion device 14 which transfers the additional flow.

The address conversion service control unit 55 specifies the first channel 21 for transferring the additional flow, in accordance with the designation of the address conversion device 14 by the request acknowledgement response. The S-GW 11 may be provided with a first channel setting table 101 for determining the first channel 21 corresponding to the address conversion device 14.

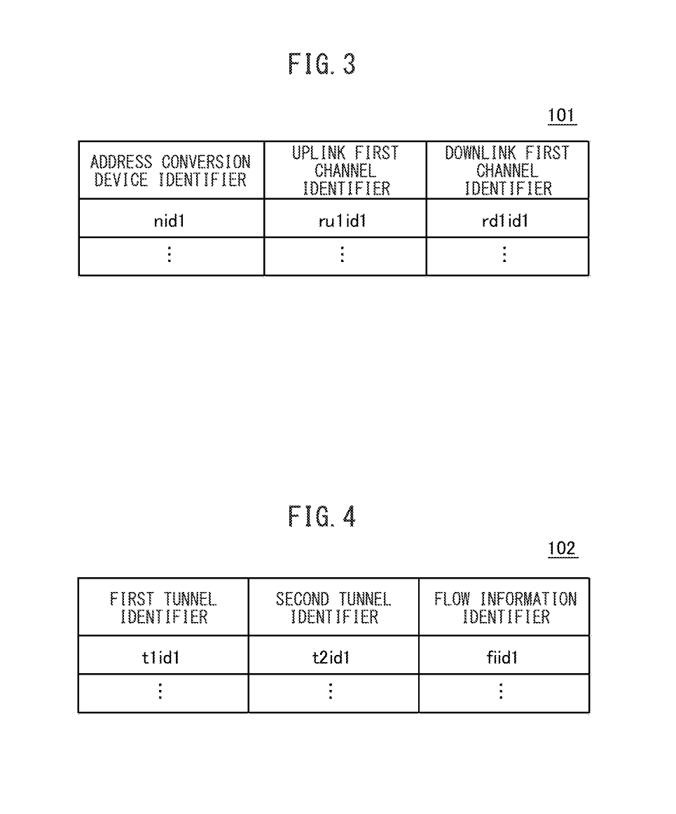

FIG. 3 is an explanatory view of one example of the first channel setting table 101. The first channel setting table 101 is provided with the information elements of the “address conversion device identifier”, “uplink first channel identifier”, and “downlink first channel identifier”. The address conversion device identifier indicates a combination of a serial number of the address conversion device 14 and communication port number for each device. The uplink first channel identifier and downlink first channel identifier are identifiers of the first channel 21 in the uplink direction and the first channel 21 in the downlink direction, which are determined for each address conversion device identifier.

In the example of FIG. 3, the first channel 21, which is identified by the uplink first channel identifier “ru1id1” and downlink first channel identifier “rd1id1”, corresponds to the port of the address conversion device 14 which is identified by the address conversion device identifier “nid1”. The first channel setting table 101 may be stored in the core network address conversion mechanism management unit 56.

The address conversion service control unit 55 sets the information for transfer of the additional flow by the first channel 21, as follows:

Between the S-GW 11 and the wireless access network 30, a first tunnel is provided, that is, a bearer which transfers the flow of the uplink direction between the base station device and S-GW 11 by the default channel. Between the S-GW 11 and the default P-GW 12#a as well, a second tunnel is provided which transfers the uplink direction flow by the default channel.

The address conversion service control unit 55 registers an identifier which identifies information specifying the uplink additional flow of the mobile station 31 which communicates by the default channel, in a table which stores the connection relationship between the first tunnel and the second tunnel forming the default channel.

FIG. 4 is an explanatory view of one example of a first relay table 102 which stores the connection relationship between the first tunnel and the second tunnel. The first relay table 102 is provided with the information elements of the “first tunnel identifier”, “second tunnel identifier”, and “flow information identifier”. For example, the first tunnel identifier and the second tunnel identifier may be combinations of tunnel IDs of the tunnels and header information of packets which are encapsulated at the time of tunnel transfer.

The flow information identifier is an identifier of information which specifies the additional flow of the mobile station 31 which communicates by the default channel identified by the first tunnel identifier and the second tunnel identifier. The first relay table 102 may be stored in the bearer control unit 52.

In the example of FIG. 4, the information, which specifies the additional flow of the mobile station 31 communicating by the default channel identified by the first tunnel identifier “t1id1” and second tunnel identifier “t2id2”, is identified by the flow information identifier “fiid”.

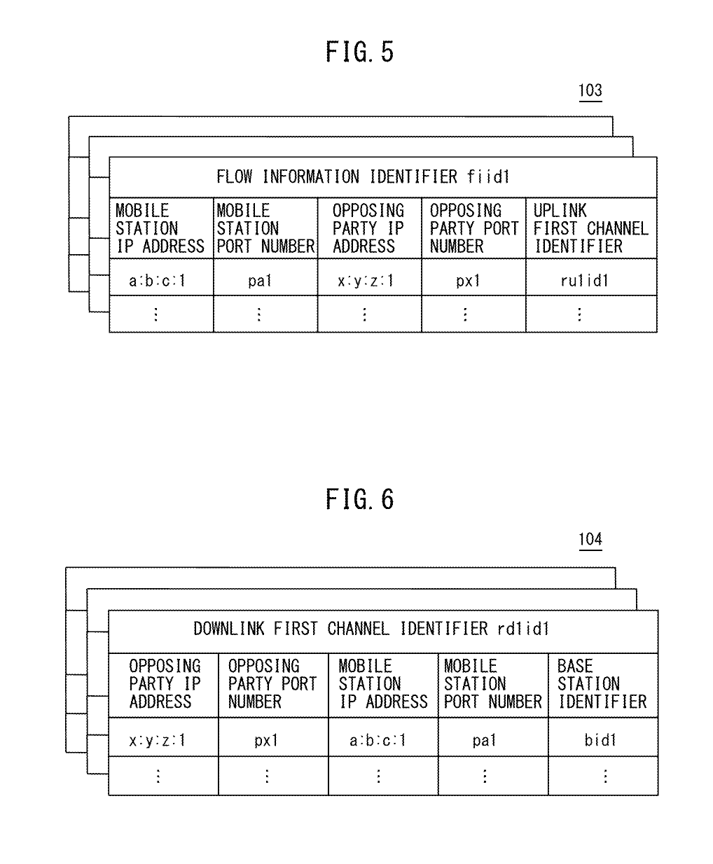

The address conversion service control unit 55 registers, in a branched flow processing table 103, combinations of information for specifying an additional flow and a first channel 21 for transferring the additional flow. FIG. 5 is an explanatory view of one example of a branched flow processing table 103. The branched flow processing table 103 is provided for each flow information identifier. The branched flow processing table 103 of each flow information identifier includes the information elements of the “mobile station IP address”, “mobile station port number”, “opposing party IP address”, “opposing party port number”, and “uplink first channel identifier”. The branched flow processing table 103 may be stored in the core network address conversion mechanism management unit 56.

The mobile station IP address and mobile station port number are the IP address and TCP/UDP port number of the mobile station 31#1 which sends and receives the additional flow. The opposing party IP address and opposing party port number are the IP address and TCP/UDP port number of the opposing party CDN cache server 42#j of the additional flow. The mobile station IP address, mobile station port number, opposing party IP address, and opposing party port number are used to specify the uplink additional flow.

The uplink first channel identifier is the identifier of the first channel 21 which transfers the uplink additional flow. In the example of FIG. 5, the information for specifying the additional flow includes the mobile station IP address “a:b:c:1”, the mobile station port number “pa1”, the opposing party IP address “x:y:z:1”, and the opposing party port number “px1”. The identifier of this information is the flow information identifier “fiid1”, while the identifier of the first channel 21 for transferring this uplink additional flow is the uplink first channel identifier “ru1id”.

The address conversion service control unit 55 registers the flow information identifier in the first relay table 102, so as to set the first channel 21 of the branched destination of the uplink additional flow of the mobile station 31 which communicates by the default channel.

Regarding the downlink direction, the address conversion service control unit 55 generates an integrated flow processing table 104 which determines a combination of downlink additional flow transmitted by the first channel 21 and a base station of the destination, for each first channel 21 which transfers a downlink additional flow.

FIG. 6 is an explanatory view of one example of an integrated flow processing table 104. The integrated flow processing table 104 is provided for each downlink first channel identifier identifying a first channel 21 which transfers a downlink additional flow. The integrated flow processing table 104 includes the information elements of the “opposing party IP address”, “opposing party port number”, “mobile station IP address”, “mobile station port number”, and “base station identifier”. The integrated flow processing table 104 may be stored in the core network address conversion mechanism management unit 56.

The contents of the opposing party IP address, opposing party port number, mobile station IP address, and mobile station port number are the same as the information elements of the same names of the branched flow processing table 103. The opposing party IP address, opposing party port number, mobile station IP address, and mobile station port number are used to specify the downlink additional flow. The base station identifier is an identifier of the base station forming the cell to which the the mobile station 31 of the destination of the downlink additional flow is connected.

In the example of FIG. 6, the information which specifies the additional flow includes the opposing party IP address “x:y:z:1”, the opposing party port number “px1”, the mobile station IP address “a:b:c:1”, and the mobile station port number “pa1”. The identifier of the first channel 21 which transfers the downlink additional flow is the downlink first channel identifier “rd1id”. The base station identifier of the destination of this downlink additional flow is “bid1”.

Between the S-GW 11 and the base station, a third tunnel is provided, that is, a bearer which transfers the downlink direction flow by a default channel. The base station identifier is linked with the third tunnel, which is provided between the base station and the S-GW 11, by the destination designation table 105.

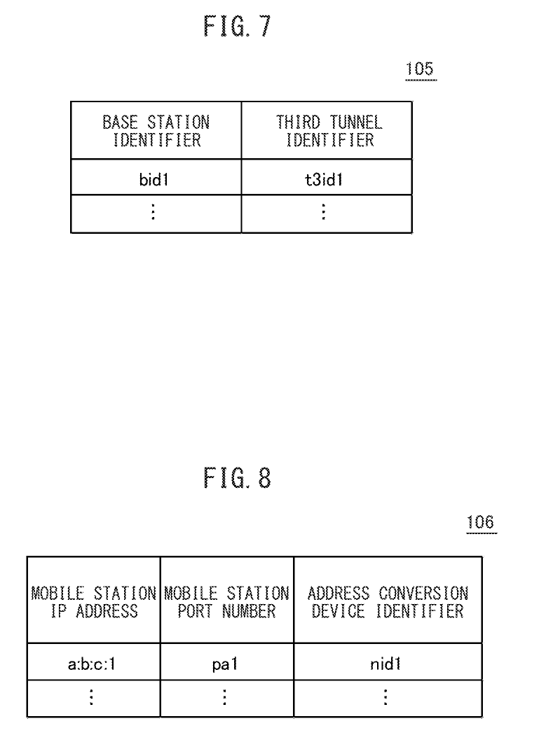

FIG. 7 is an explanatory view of one example of a destination designation table 105. The destination designation table 105 is provided with the information elements of the “base station identifier” and “third tunnel identifier”. The base station identifier is the identifier of the base station to which the default channel is set with the S-GW 11. The third tunnel identifier is the identifier of the third tunnel which forms the default channel.

The address conversion service control unit 55 register the base station identifier in the integrated flow processing table 104, so that it can determine which default channel is to be integrated with the downlink additional flow of the mobile station 31 which communicates by a certain default channel.

Note that, in the following explanation, generation of entries in the branched flow processing table 103 and the integrated flow processing table 104 for making the additional flow be transmitted by the first channel 21, will sometimes be referred to as “setting the flow processing information”.

The communication data processing unit 51 judges if an entry of flow of received packets has been made in the branched flow processing table 103, when receiving uplink packets. When an entry of flow of received packets has been made in the branched flow processing table 103, the communication data processing unit 51 transfers the received packets by the first channel 21#1 which is designated in accordance with the branched flow processing table 103. When an entry of flow of received packets has not been made in the branched flow processing table 103, the communication data processing unit 51 transmits the received packets by the default channel.

The communication data processing unit 51 judges if an entry of flow of received packets has been made in the integrated flow processing table 104, when receiving downlink packets. When an entry has been made in the integrated flow processing table 104, the communication data processing unit 51 transfers the received packets by the third tunnel which is set with the base station designated by the integrated flow processing table 104.

Next, if handover of the mobile station 31#1 results in the connection destination of the mobile station 31#1 being changed from another S-GW to the S-GW 11, the MME 13 sends a handover procedure message to the S-GW 11. In the following explanation and attached drawings, handover will sometimes be referred to as “HO”.

The address conversion service control unit 55 judges if address conversion device route communication information of the mobile station 31#1 has been added to the HO procedure message sent from the MME 13. The address conversion device route communication information includes information relating to the additional flow of the mobile station 31#1 and information which designates, before HO, the address conversion device 14 routed through the additional flow. In the following explanation, the address conversion device 14 routed through the additional flow before HO is assumed to be the address conversion device 14#x.

The address conversion service control unit 55 judges, based on the first channel setting table 101, if a first channel 21 has been set with the address conversion device 14#x designated by the address conversion device route communication information. When the first channel 21 has been set, the address conversion service control unit 55 prepares an entry in the branched flow processing table 103 so as to make the first channel 21 transmit the uplink additional flow with the designated address conversion device 14#x. Further, the address conversion service control unit 55 generates an entry of the integrated flow processing table 104 so as to make the downlink additional flow be transmitted by the first channel 21 with the address conversion device 14#x.

When the first channel 21 is not set, the address conversion service control unit 55 starts resource change processing so as to make the flow be transmitted routed through another address conversion device 14. The address conversion service control unit 55 transmits a resource request to the channel control device 15, which requests designation of another address conversion device 14 for transfer of the additional flow.

The resource request may include an identifier of the S-GW 11, an identifier of the P-GW 12#b which holds the additional flow, and an identifier of the external network 40#1. The resource request may include an identifier of the address conversion device 14#x which transferred the additional flow before HO and the address of the mobile station 31#1 at which the HO occurred.

The address conversion service control unit 55 receives a request acknowledgement response to the resource request from the channel control device 15. The request acknowledgement response may include information which designates another address conversion device 14 for transferring the additional flow. In the following explanation of “2.1. S-GW”, the address conversion device 14 which the request acknowledgement response designates, is assumed as being the address conversion device 14#y.

The address conversion service control unit 55 sets the flow processing information for transfer of the additional flow by the first channel 21 with the address conversion device 14#y.

The address conversion service control unit 55 registers the address of the mobile station 31#1 and the address conversion device 14 designated by the request acknowledgement response in the address conversion device table 106, when receiving the request acknowledgement response to the address conversion device route communication request.

FIG. 8 is an explanatory view of one example of the address conversion device table 106. The address conversion device table 106 is provided with the information elements of the “mobile station IP address”, “mobile station port number”, and “address conversion device identifier”. The address conversion device table 106 may be stored in the core network address conversion mechanism management unit 56.

The mobile station IP address and mobile station port number are the IP address and TCP/UDP port number of the mobile station 31#1 which sends and receives the additional flow. The address conversion device identifier indicates a combination of the serial number of the address conversion device 14 and the communication port number for each device. In the example of FIG. 8, the address conversion device for transferring the additional flow of the mobile station 31#1, which is identified by the mobile station IP address “a:b:c:1” and the mobile station port number “pa1”, and the communication port of that address conversion device, are identified by the identifier “nid1”.

The address conversion service control unit 55 similarly registers the address of the mobile station 31#1 and the address conversion device 14 designated by the request acknowledgement response in the address conversion device table 106, even when receiving a request acknowledgement response to a resource change request.

2.2. Channel Control Device

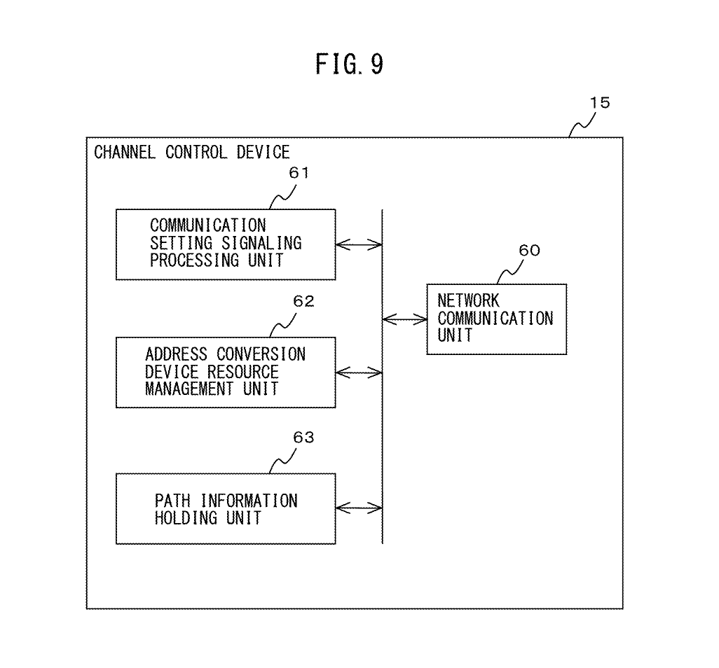

FIG. 9 is a view of the functional configuration of one example of the channel control device 15. The channel control device 15 is comprised of a network communication unit 60, communication setting signaling processing unit 61, address conversion device resource management unit 62, and path information holding unit 63.

The address conversion device resource management unit 62 is one example of an address conversion device selection unit, address information acquisition unit, address information transmission unit, and calculation method specification unit.

The path information holding unit 63 is one example of a setting storage unit, calculation method storage unit, and usage condition storage unit.

The network communication unit 60 terminates communication protocols of the physical layer, data link layer, and network layer inherent to the communication network 10 and transfers data with other node devices of the communication network 10.

The communication setting signaling processing unit 61 receives from an S-GW 11 an address conversion device route communication request for requesting transfer of the additional flow routed through an address conversion device 14.

The address conversion device resource management unit 62 judges if there is an address conversion device 14 for routing the additional flow. The channel control device 15 is provided with a second channel setting table 107 which determines a combination of an S-GW 11, P-GW 12, external network 40, and address conversion device 14 for which a first channel 21 and second channel 22 are set. The second channel setting table 107 may be stored in the path information holding unit 63.

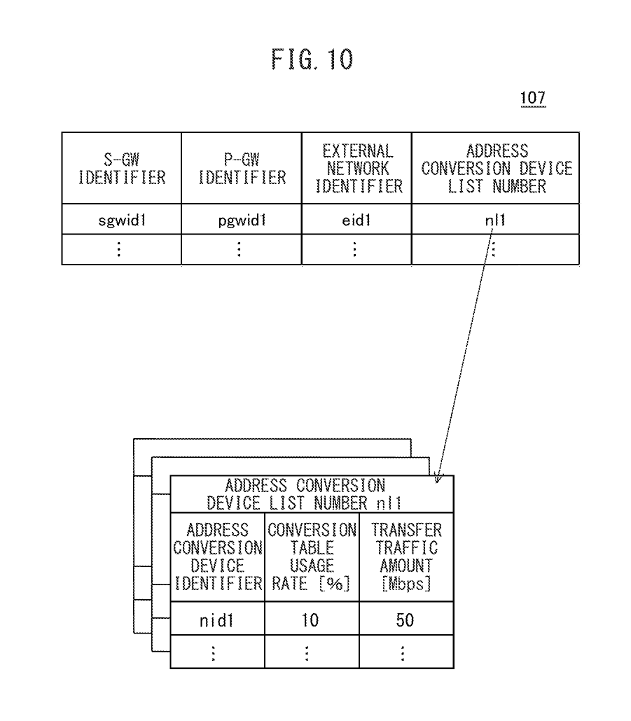

FIG. 10 is an explanatory view of a first example of the second channel setting table 107. The second channel setting table 107 is provided with a first table which includes the information elements of the “S-GW identifier”, “P-GW identifier”, “external network identifier”, and “address conversion device list number”.

The S-GW identifier, P-GW identifier, and external network identifier are identifiers of the S-GW 11, the P-GW 12, and the external network 40. The address conversion device list number is the identifier of the set of address conversion device identifiers. Each entry of the first table designates a combination of the S-GW 11, P-GW 12, external network 40, and address conversion device 14, for which a first channel 21 and second channel 22 are set.

The example of FIG. 10 designates a combination of an address conversion device identifier, S-GW identifier “sgwid1”, P-GW identifier “pgwid1” and external network identifier “eid”, which are included in the set designated by the address conversion device list number “n11”. The first channel 21 and second channel 22 are set for this combination.

The combination of the S-GW 11, address conversion device 14, and first channel 21 which is provided between them, is determined by the first channel setting table 101 of FIG. 3 which is preset in the S-GW 11. Similarly, the combination of the address conversion device 14, P-GW 12, and second channel 22 which is provided between them, is determined by the later explained third channel setting table 113 of FIG. 18 which is preset in the P-GW 12. Therefore, the second channel setting table 107, which determines the combination of the S-GW 11, P-GW 12, and address conversion device 14, determines the corresponding combination of the first channel 21 and the second channel 22.

The second channel setting table 107 is provided with a second table, which determines the set of address conversion device identifiers identified by the address conversion device list number, for each address conversion device list number. The second table is provided with the information elements of the “address conversion device identifier”, “conversion table usage rate”, and “transfer traffic amount”.

The address conversion device identifier indicates the combination of the serial number of the address conversion device 14 and the communication port number for each device. The conversion table usage rate indicates the rate of use of the address conversion table 108 explained later which is provided for each communication port of the address conversion device 14. The transfer traffic amount indicates the amount of transfer traffic for each communication port.

The communication setting signaling processing unit 61 collects, from the address conversion devices 14, information on the usage rate of the address conversion table 108 and transfer traffic amount and stores it in the second channel setting table 107.

The address conversion device resource management unit 62 judges if there is an entry, in the second channel setting table 107, which entry includes all of the identifiers of the S-GW 11, P-GW 12#b, and external network 40#1 which were designated by the address conversion device route communication request. If there is the entry in the second channel setting table 107, it judges that there is an address conversion device 14 routed through the additional flow.

When there are a plurality of address conversion devices 14 routed through the additional flow, the address conversion device resource management unit 62 selects one of them. For example, the address conversion device resource management unit 62 may follow the predetermined selection criteria, which is illustrated below, to select the address conversion device 14.

For example, the address conversion device resource management unit 62 may refer to the second channel setting table 107 and select an address conversion device 14 indicating a transfer traffic amount smaller than a threshold value or the address conversion device 14 indicating the smallest transfer traffic amount. For example, the address conversion device resource management unit 62 may refer to the second channel setting table 107 and select the address conversion device 14 indicating the smaller transfer delay than a threshold value or the address conversion device 14 indicating the smallest transfer traffic amount. The address conversion device resource management unit 62 may select the address conversion device 14 indicating the smallest transfer delay from the S-GW 11 transmitting the address conversion device route communication request. The unit 62 may select the address conversion device 14 indicating the smallest transfer delay from the S-GW 11 transmitting the address conversion device route communication request. The unit 62 may select the address conversion device 14 which satisfies all of these selection criteria.

The address conversion device resource management unit 62 sends, to the S-GW 11, a request acknowledgement response to the address conversion device route communication request. The request acknowledgement response includes information which designates the selected address conversion device 14.

Further, the communication setting signaling processing unit 61 receives, from the S-GW 11 to which the mobile station 31#1 is newly connected by HO of the mobile station 31#1, a resource request which requests designation of another address conversion device 14 for transfer of the additional flow. In the following explanation of “2.2. Channel Control Device”, the S-GW which sent the resource request is assumed to be the S-GW 11#b.

The address conversion device resource management unit 62 judges if there is an address conversion device 14 routed through the additional flow. The address conversion device resource management unit 62 judges if there is an entry, in the second channel setting table 107, which includes all of the identifiers of the S-GW 11#b, P-GW 12#b, and external network 40#1 which are designated by the resource request. If there is an entry of these in the second channel setting table 107, it judges that there is an address conversion device 14 routed through the additional flow.

If there are a plurality of address conversion devices 14 routed through the additional flow, the address conversion device resource management unit 62 follows predetermined selection criteria to select one of the plurality of address conversion devices 14 such as the address conversion device 14#y.

The address conversion device resource management unit 62 sends a request acknowledgement response to the resource request to the S-GW 11. The request acknowledgement response includes information which designates the selected address conversion device 14#y.

The address conversion device resource management unit 62 sends a conversion information continuation instruction to the address conversion device 14#x through which the additional flow of the mobile station 31#1 was routed before HO. The conversion information continuation instruction is a signal which includes the address of the mobile station 31#1 and requests the external address allocated to the mobile station 31#1 by the address conversion device 14#x.

The address conversion device resource management unit 62 receives, from the address conversion device 14#x, the external address which is allocated to the mobile station 31#1 by the address conversion device 14#x. The address conversion device resource management unit 62 sends the address and external address of the mobile station 31#1 to the address conversion device 14#y.

The address conversion device resource management unit 62 notifies the P-GW 12#b of the second channel 22 between the P-GW 12#b and the address conversion device 14#y and the external address of the mobile station 31#1.

2.3. Address Conversion Device

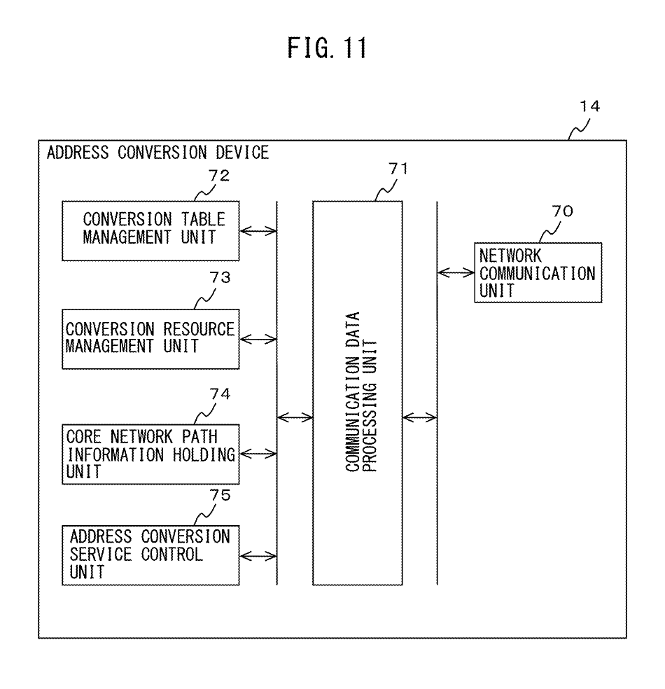

FIG. 11 is a view of the functional configuration of one example of an address conversion device 14. The address conversion device 14 is comprised of a network communication unit 70, communication data processing unit 71, conversion table management unit 72, conversion resource management unit 73, core network internal path information holding unit 74, and address conversion service control unit 75.

The communication data processing unit 71 is one example of a transfer unit.

The conversion table management unit 72 is one example of a conversion information storage unit, detection unit, conversion information update unit, calculation method storage unit, and address calculation unit.

The network communication unit 70 terminates the communication protocols of the physical layer, data link layer, and network layer inherent to the communication network 10 and sends and receives data with other node devices of the communication network 10.

The communication data processing unit 71 performs routing the data and processing relating to the data transfer use protocol, based on the setting information of the channel (bearer). The communication data processing unit 71 recognizes the signaling information etc., addressed to the address conversion device 14, and sends and receives data with other component elements in the address conversion device 14 which process this signaling information.

The communication data processing unit 71 converts the source address of packets of the uplink additional flow to an external address, based on the address conversion table 108. The communication data processing unit 71 converts the destination address of packets of the downlink additional flow to an internal address, based on the address conversion table 108, based on the address conversion table 108.

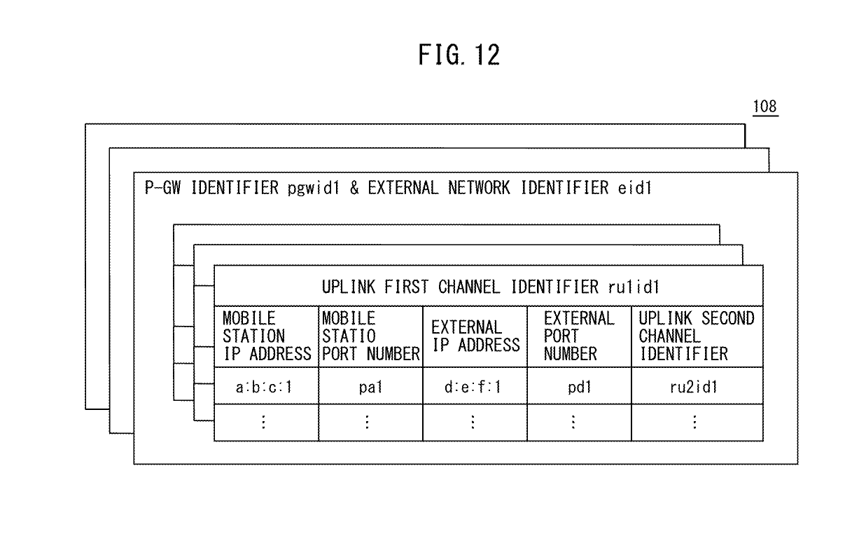

FIG. 12 is an explanatory view of one example of an address conversion table 108. The address conversion table 108 is provided for each first channel 21 in the uplink direction. The address conversion tables 108 are grouped for each P-GW 12 and for each external network 40 to which an additional flow transferred by a first channel 21 in the uplink direction is transferred. That is, groups of address conversion tables 108 of first channels 21 in the uplink direction are designated, which transfer additional flows routed through the same P-GW 12 and same external network 40.

The address conversion table 108 includes the information elements of the “external network identifier”, “P-GW identifier”, and “uplink first channel identifier”. The address conversion table 108 includes a “mobile station IP address”, “mobile station port number”, “external IP address”, “external port number”, and “uplink second channel identifier”. The address conversion table 108 is stored in the conversion table management unit 72.

The uplink first channel identifier is an identifier of the first channel 21 of the uplink direction which transfers the packets for address conversion by the communication data processing unit 71. The external network identifier and P-GW identifier are identifiers of the external network 40 and the P-GW 12 which transfer packets for address conversion.

The mobile station IP address and mobile station port number indicate the internal address of the mobile station 31#1. The external IP address and external port number indicate the external address of the mobile station 31#1 which is allocated by the address conversion device 14.

The uplink second channel identifier is the identifier of the second channel 22 which designates the second channel 22 of the uplink direction which transfers packets which have the source address designated by the mobile station IP address and mobile station port number.

In the example of FIG. 12, the first channel 21 of the uplink first channel identifier “ru1id1” receives packets having the source address of the IP address “a:b:c:1” and port number “pa1”. The external address, which is allocated as the source address of the packets, is the IP address “d:e:f:1” and port number “pd1”. The additional flow transferred by this first channel 21 is transferred by the P-GW 12 of the P-GW identifier “pgwid1” and the external network 40 of the external network identifier “eid1”.

When receiving uplink packets, the communication data processing unit 71 refers to the address conversion table 108 corresponding to the first channel 21 which received the packets, and detects an entry of the source address of the received packets. The communication data processing unit 71 specifies the external address and second channel 22 from the detected entry.

The communication data processing unit 71 converts the source address of the received packets to the specified external address. The communication data processing unit 71 transfers the received packets by the specified second channel 22.

When receiving downlink packets, the communication data processing unit 71 detects an entry having the source address of the received packets, as an external address, from the address conversion table 108. The communication data processing unit 71 specifies the internal address from the detected entry. The communication data processing unit 71 specifies the first channel 21 of the uplink direction, based on from which address conversion table 108 the entry is detected.

The communication data processing unit 71 specifies the downlink direction first channel 21, based on the second relay table 109, which determines the combination of the uplink direction first channel 21 and the downlink direction first channel 21, and the specified uplink direction first channel 21. The communication data processing unit 71 transfers the downlink received packets by the specified first channel 21 of the downlink direction.

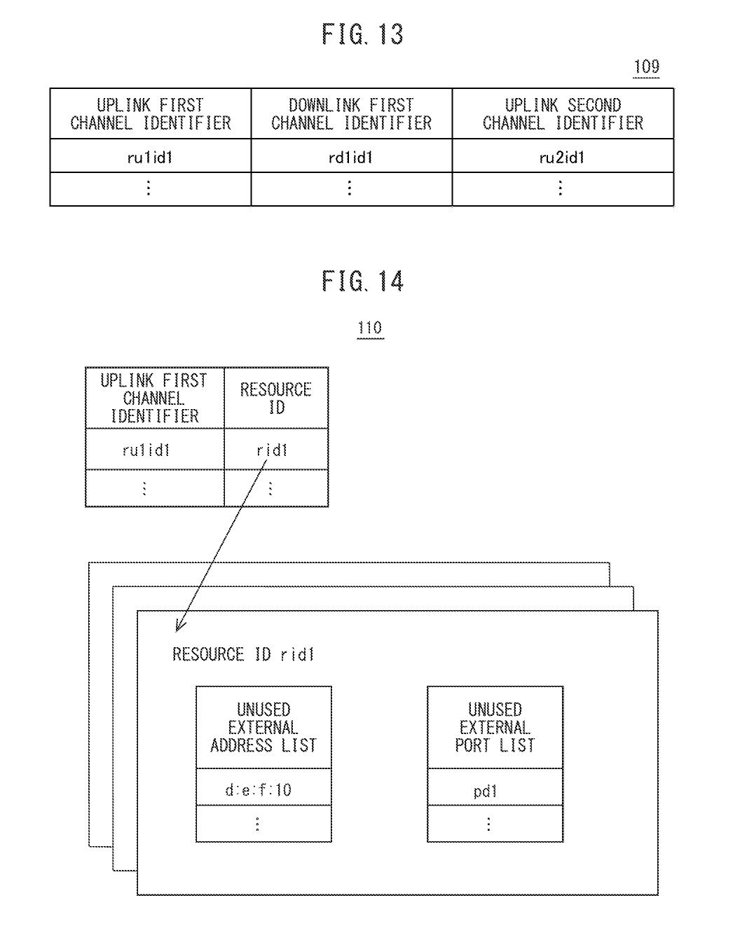

FIG. 13 is an explanatory view of one example of the second relay table 109. The second relay table 109 is provided with the information elements of the “uplink first channel identifier”, “downlink first channel identifier”, and “uplink second channel identifier”. The second relay table 109 may be stored in the core network internal path information holding unit 74.

The uplink first channel identifier, downlink first channel identifier, and uplink second channel identifier are identifiers of first channel 21 of the uplink direction, the first channel 21 of the downlink direction, and the second channel 22 of the uplink direction, which transfer the additional flow of the mobile station 31#1. Each entry of the second relay table 109 defines a combination of the first channel 21 of the uplink direction, the first channel 21 of the downlink direction, and the second channel 22 of the uplink direction, which transfer the additional flow of the mobile station 31#1.

In the example of FIG. 13, the additional flow of the mobile station 31#1 is transferred by the first channel 21 of the uplink first channel identifier “ru1id1” and the first channel 21 of the downlink direction of the downlink first channel identifier “rd1id1”. Further, the additional flow of the mobile station 31#1 is transferred by the second channel 22 of the second channel identifier “ru2id1”.

The conversion table management unit 72 registers entries, changes entries, and deletes entries at the address conversion table 108. If there is no entry of the source address of the received uplink packets in the address conversion table 108 of the first channel 21 which has received the packets, the conversion table management unit 72 acquires the external address from the resource management table 110.

FIG. 14 is an explanatory view of one example of a resource management table 110. The resource management table 110 is provided with the information elements of the “uplink first channel identifier” and “resource ID”. The uplink first channel identifier indicates the identifier of the first channel 21 of the uplink direction. The resource ID is the identifier of the list of resources of the external addresses. The list is prepared for each first channel 21. The resource management table 110 may be stored in the conversion resource management unit 73.

Each list of resources of the external addresses includes one or more unused external addresses which can be used for each first channel 21. An address region, which can be used for an external address of additional flow, is allocated to each second channel 22. For this reason, an address region of external addresses, which are included in the list, is allocated in accordance with the second channel 22 which corresponds to the first channel 21.

In the example of FIG. 14, the resource ID in the list of unused resources for the first channel 21 of the uplink first channel identifier “ru1id1” is “rid1”. This list includes, as an unused external address, the IP address “d:e:f:10” and port number “pd1”.

The conversion table management unit 72 generates an entry, which converts the address of the received packets to an external address acquired from the resource management table 110 at the address conversion table 108 of the first channel 21 which received the packets. The conversion table management unit 72 specifies the second channel 22 of the uplink direction corresponding to the first channel 21 of the uplink direction which received the packets, based on the second relay table 109. The conversion table management unit 72 registers the specified second channel 22 in the information element “uplink second channel identifier” of the generated entry.

Assume the case where HO of the mobile station 31#1 causes the S-GW 11, which is the connection destination of the mobile station 31#1, to change. If the S-GW 11 of the connection destination changes, the first channel 21, which transfers the additional flow of the mobile station 31#1, changes. In the following explanation of “2.3. Address Conversion Device”, assume that the first channel 21, which transfers the additional flow of the mobile station 31#1 before HO, is the first channel 21#1 and that the first channel 21, which transfers the additional flow of the mobile station 31#1 after HO, is the first channel 21#2. In this case, there is no entry corresponding to the source address of the received packets of the uplink additional flow in the address conversion table 108 of the first channel 21#2 after HO.

The conversion table management unit 72 refers to the group of the address conversion tables 108 of the first channels 21 which transfer additional flows to the P-GW's 12 and external networks 40, in the same way as the first channel 21#2.

If there is an entry corresponding to the received packets in the address conversion table 108 of the first channel 21#1 in this group, the conversion table management unit 72 moves this entry to the address conversion table 108 of the first channel 21#2.

If HO causes the address conversion device 14, which transfers the additional flow of the mobile station 31#1, to change, there is no entry corresponding to the received packets in the address conversion table 108 which this address conversion device 14 is provided with. In this case, the conversion table management unit 72 receives an external address, from the channel control device 15, which another address conversion device gives to the additional flow of the mobile station 31#1 before the HO.

The conversion table management unit 72 generates an entry, which converts the address of the received packets to an external address which is received from the channel control device 15, at the address conversion table 108 of the first channel 21 which receives the packets.

The address conversion service control unit 75 receives, from the channel control device 15, the conversion information continuation instruction by which the address conversion device 14 inquires about the external address allocated to the mobile station 31. The address conversion service control unit 75 detects, from the address conversion table 108, an entry of the address of the mobile station 31#1 which is designated by the conversion information continuation instruction. The address conversion service control unit 75 sends the external address of the mobile station 31#1 which is stored at the detected entry to the channel control device 15.

2.4. P-GW

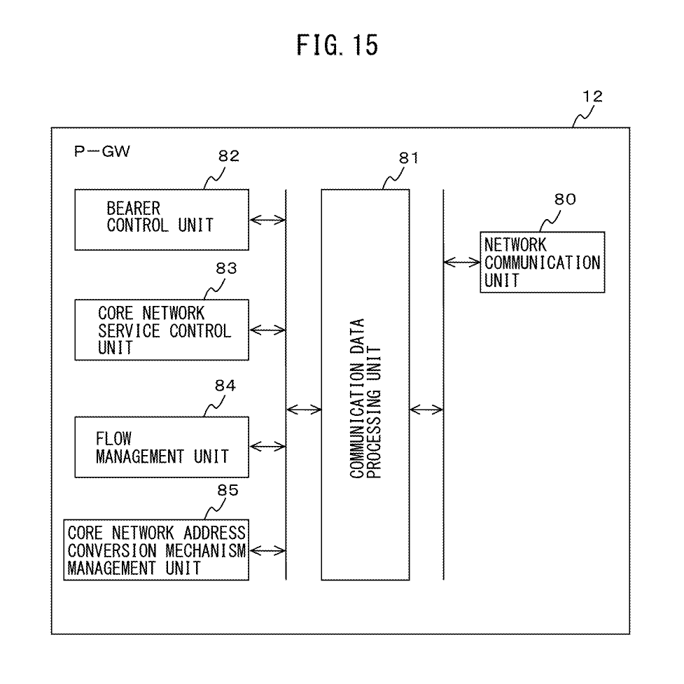

FIG. 15 is a view of the functional configuration of one example of a P-GW 12. The P-GW 12 comprises a network communication unit 80, communication data processing unit 81, bearer control unit 82, core network service control unit 83, flow management unit 84, and core network address conversion mechanism path management unit 85.

The network communication unit 80 terminates communication protocols of the physical layer, data link layer, and network layer, inherent to the communication network 10, and transfers data with other node devices of the communication network 10.

The communication data processing unit 81 performs routing of data and processing relating to the data transfer use protocol, based on the setting information of the channel (bearer). The communication data processing unit 81 recognizes the signaling information addressed to the P-GW 12 etc. and transfers data with other component elements in the P-GW 12 which process this signaling information.

The bearer control unit 82 sets, releases, and changes the transfer information to the communication data processing unit 81 and holds and manages the setting information, based on the information which is received from the core network service control unit 83. The core network service control unit 83 performs signaling processing for providing mobile communication services with the S-GW 11, other P-GW 12, and MME 13.

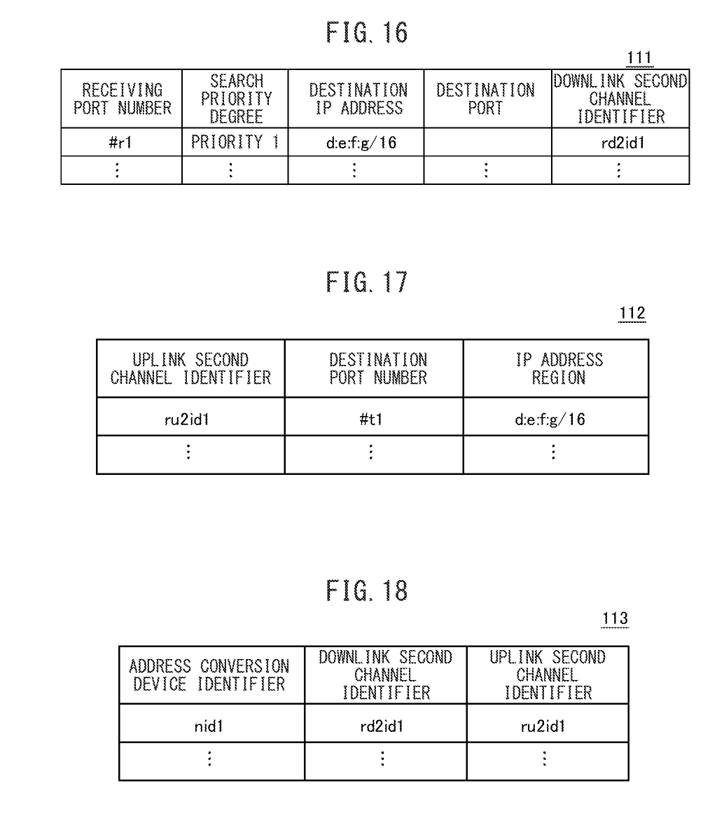

The flow management unit 84 follows the downlink transfer table 111 to transfer the packets of the downlink additional flow, which was received from the external network 40#1, by the second channel 22. FIG. 16 is an explanatory view of one example of the downlink transfer table 111. The downlink transfer table 111 is provided with information elements of the “received port number”, “search priority degree”, “destination IP address”, “destination IP port”, and “downlink second channel identifier”. The flow management unit 84 may store the downlink transfer table 111.

The reception port number identifies the reception port of the P-GW 12 which is to receive the downlink additional flow. The downlink second channel identifier indicates the second channel 22 of the downlink direction which transfers the downlink additional flow. The “destination IP address” and “destination port” indicate the “IP address” of the external address of the packets of the downlink additional flow, which are transferred to this second channel 22, and the “TCP/UDP port number”. The external address may be designated by an individual IP address or may be designated by an address region. The information element “search priority degree” will be explained later.

In the example of FIG. 16, packets of additional flow of the address region “d:e:f:g/16”, which is designated by the destination IP address, are received at the reception port “#r1” and are transferred to the second channel 22 of the downlink second channel identifier “rdid1”.

The flow management unit 84 transfers the received packets to the second channel 22 which is determined in accordance with the designation of the external address of the downlink transfer table 111, based on the external address which was designated as the destination address of the downlink received packets.

The flow management unit 84 transfers the uplink additional flow, which was received from the second channel 22, to the external network 40#1 in accordance with an uplink transfer table 112. FIG. 17 is an explanatory view of one example of the uplink transfer table 112. The uplink transfer table 112 includes the information elements of the “uplink second channel identifier”, “destination port number”, “IP address region”. The flow management unit 84 may store the uplink transfer table 112.

The uplink second channel identifier indicates the second channel 22 of the uplink direction at which the uplink additional flow is received. The destination port number identifies the transmitting port of the P-GW 12 which sends the uplink additional flow to the external network 40#1. The IP address region designates the address region of the external address allocated to the second channel 22 which is designated by the uplink second channel identifier.

In the example of FIG. 17, the packets, which is received by the second channel 22 of the uplink second channel identifier “ruid1”, are transferred from the transmitting port “#t1” to the external network 40#1. The address region which is allocated to this second channel 22 is “d:e:f:g/16”.

The flow management unit 84 transfers received packets according to the designation of the destination port number of the uplink transfer table 112 depending on the first channel 21 which received the uplink packets.

If HO of the mobile station 31#1 causes the address conversion device 14, which transfers the additional flow of the mobile station 31#1, to changes, the second channel 22 by which the P-GW 12 transfers the additional flow also changes. In the following explanation of “2.4. P-GW”, the case is assumed, where the address conversion device 14 and second channel 22, through which the additional flow was transferred before HO, are the address conversion device 14#x and channel 22#x. The case is assumed, where the address conversion device 14 and second channel 22 through which the additional flow is transferred after HO are the address conversion device 14#y and channel 22#y.

The core network address conversion mechanism path management unit 85 receives notification, from the channel control device 15, of the external address of the mobile station 31#1 and the second channel 22#y.

The core network address conversion mechanism path management unit 85 individually changes the destination of the downlink additional flow of the mobile station 31#1, which was designated by the downlink transfer table 111, to the second channel 22#y. That is, in the downlink transfer table 111, an entry, in which the external address of the mobile station 31#1 is stored, is individually generated and the value of that information element “second channel identifier” is changed to the identifier of the second channel 22#y.

Due to this entry, the P-GW 12 can transfer the additional flow to the second channel 22#y, even if the external address, which the address conversion device 14#x allocated to the mobile station 31#1, is not in the address region which is allocated to the second channel 22#y. For this reason, even if the second channel 22, which transfers the additional flow, is changed, the same external address can continue to be used.

In this case, there are both an entry which designates the second channel 22#x as the destination of the flow of the address region including the external address of the mobile station 31#1 and an entry which designates the second channel 22#y as the destination of the flow of the external address of the mobile station 31#1. To prevent packets of the mobile station 31#1 from being mistakenly transferred to the second channel 22#x, it is desirable that the entry which designates the second channel 22#y be referred to, with priority over the entry which designates the second channel 22#x.

For this reason, the core network address conversion mechanism path management unit 85 sets, as the search priority degree of the entry, a higher priority degree than the priority degree of the entry, which designates the destination for each address region, with respect to an entry which designates the destination by address region units. The core network address conversion mechanism path management unit 85 stores the search priority degree of an entry of the downlink transfer table 111 in the information element “search priority degree”. The flow management unit 84 selects, when selecting a second channel 22 for transferring packets of a downlink additional flow the second channel 22 which is designated by an entry to which a higher search priority degree is set.

The core network address conversion mechanism path management unit 85 may change the designation of the downlink additional flow of the mobile station 31#1 which is designated by the downlink transfer table 111, when receiving packets of an uplink additional flow.

When the core network address conversion mechanism path management unit 85 detects received packets of an uplink additional flow, it refers to the address region which is determined by the uplink transfer table 112 for the second channel 22 which transfers the packets. If the external address of the received packets is not in the address region, the core network address conversion mechanism path management unit 85 refers to a third channel setting table 113 which designates combinations of the second channels 22 of the uplink direction and second channels 22 of the downlink direction.

FIG. 18 is an explanatory view of one example of the third channel setting table 113. The third channel setting table 113 is provided with the information elements of the “address conversion device identifier”, “downlink second channel identifier”, and “uplink second channel identifier”. The third channel setting table 113 may be stored in the core network address conversion mechanism path management unit 85.

Each entry determines a combination of a second channel 22 in the downlink direction and a second channel 22 in the uplink direction, which are provided between a P-GW 12 and an address conversion device 14. In the example of FIG. 18, there are a second channel 22 of the downlink direction having the downlink second channel identifier “rd2id1” and a second channel 22 of the uplink direction having the uplink second channel identifier “ru2id1”, with the address conversion device 14 having the address conversion device identifier “nid1”.

The core network address conversion mechanism path management unit 85 changes the destination of the downlink additional flow of the mobile station 31#1, which is designated by the downlink transfer table 111, to the second channel 22 of the downlink direction corresponding to the second channel 22 of the uplink direction receiving the packets.

2.5. MME

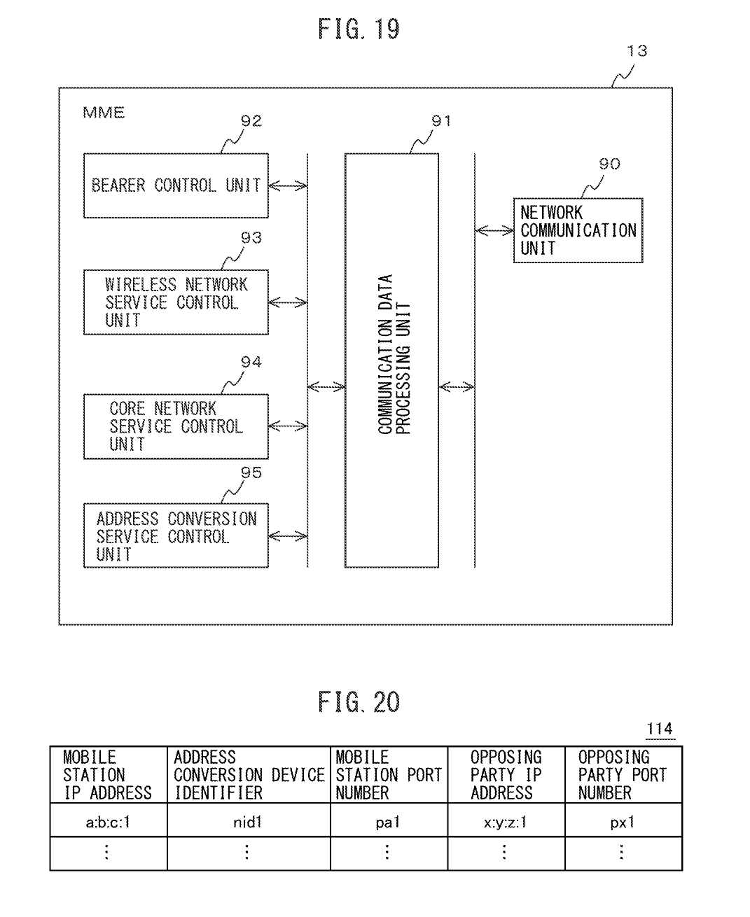

FIG. 19 is an explanatory view of one example of an MME 13. The MME 13 is comprised of a network communication unit 90, communication data processing unit 91, bearer control unit 92, wireless network service control unit 93, core network service control unit 94, and address conversion service control unit 95.

The network communication unit 90 terminates the communication protocols of the physical layer, data link layer, and network layer inherent to the communication network 10 and transfers data with other node devices of the communication network 10.

The communication data processing unit 91 recognizes the signaling information etc. addressed to the MME 13 and transfers data with other component elements in the MME 13 which process this signaling information. The bearer control unit 92 holds and manages the information of a channel set at a mobile station 31, base station, S-GW 11 and the P-GW 12 through the wireless network service control unit 93 and core network service control unit 94.

The wireless network service control unit 93 performs signaling processing with the base station for the mobile communication service. The core network service control unit 94 performs signaling processing with the mobile station 31, base station, and S-GW 11 for the mobile communication service. The core network service control unit 94 detects HO of the mobile station 31 and performs an HO procedure.

If HO of the mobile station 31 is detected, the address conversion service control unit 95 judges if the additional flow of the mobile station 31, which performed the HO, is being transferred by the first channel 21 and second channel 22. For example, the address conversion service control unit 95 judges whether the address conversion device route communication information of the mobile station 31#1 was received from the S-GW 11 in the past and is stored in an address conversion device route flow table 114.

FIG. 20 is an explanatory view of one example of the address conversion device route flow table 114. The address conversion device route flow table 114 is provided with the information elements of the “mobile station IP address”, “address conversion device identifier”, “mobile station port number”, “mobile station IP address”, and “mobile station port number”. The address conversion service control unit 95 may be provided with the address conversion device route flow table 114.

The contents of the mobile station IP address, mobile station port number, opposing party IP address, and opposing party port number are similar to the information elements of the same names of the branched flow processing table 103. The address conversion device identifier is the identifier of the address conversion device 14 which transfers the additional flow. In the example of FIG. 20, the address conversion device 14 of the identifier “nid1” transfers the additional flow which has the mobile station IP address “a:b:c:1”, mobile station port number “pa1”, the opposing party IP address “x:y:z:1”, and opposing party port number “px1”.

When the address conversion device route communication information is stored in the address conversion device route flow table 114, the address conversion service control unit 95 may judge that the additional flow is being transferred by the first channel 21 and second channel 22.

The address conversion service control unit 95 adds the address conversion device route communication information of the mobile station 31#1, which is stored in the address conversion device route flow table 114, to the HO procedure message and sends the result to the S-GW 11 of the HO target.

### 3. Explanation of Operation

### 3.1. New Channel Setting Operation

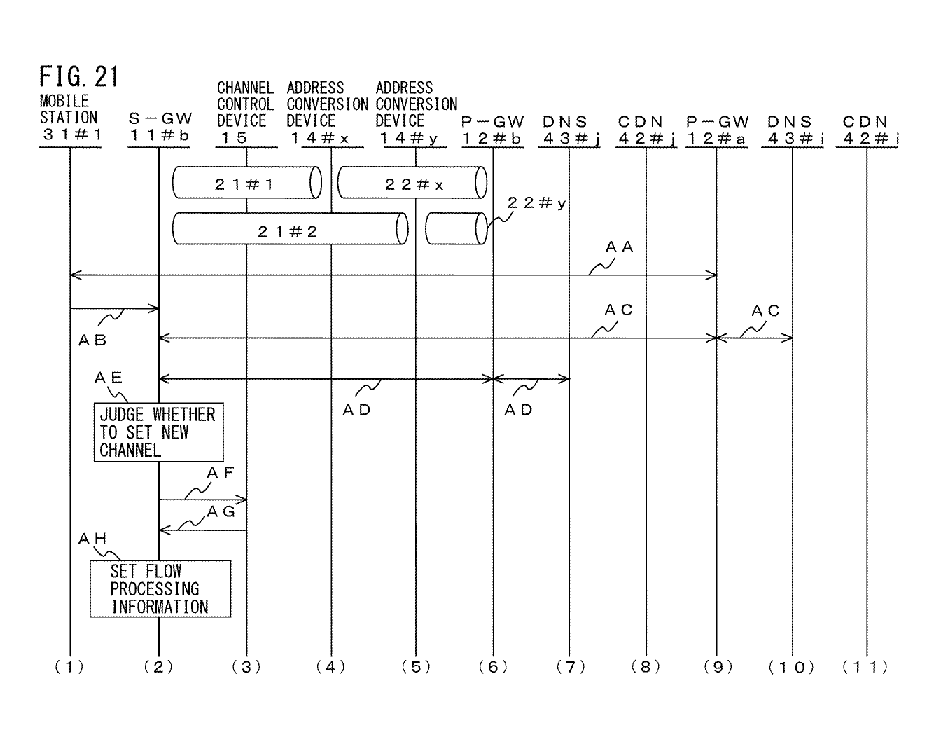

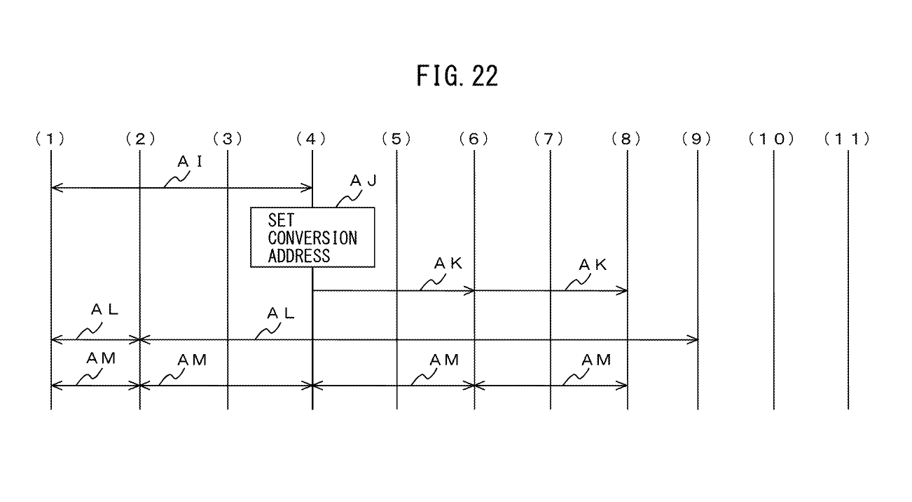

Next, the operations of the component elements of the communication system 1 will be explained. FIG. 21 and FIG. 22 are explanatory views of one example of a new channel setting operation. Referring to FIG. 21 and FIG. 22, the overall operation when setting a new channel will be explained.

Between the P-GW 12#b and the address conversion device 14#x, a second channel 22#x is set, while between the S-GW 11#b and the address conversion device 14#x, a first channel 21#1 corresponding to the second channel 22#x is set. Between the P-GW 12#b and the address conversion device 14#y, a second channel 22#y is set, while between the S-GW 11#b and the address conversion device 14#y, a first channel 21#2 corresponding to the second channel 22#y is set.

At the operation AA, the mobile station 31#1 which is connected to the S-GW 11#b, communicates with an external network 40 routed through a default channel with the default P-GW 12#a.

At the operation AB, the mobile station 31#1, which accesses the CDN cache server 42, transmits a DNS request for translating address of the contents server to the S-GW 11#b. At the operation AC, the S-GW 11#b transmits this through the P-GW 12#a to the DNS server 43#i. As a result, the S-GW 11#b receives a DNS response notifying the address of the CDN cache server 42#i.

At the operation AD, the S-GW 11#b transmits the DNS request through the P-GW 12#b, different from the P-GW 12#a, to the DNS server 43#j. The P-GW 12#b, for example, may be a node device which is closer to the S-GW 11#b than the P-GW 12#a. The S-GW 11#b receives from the DNS server 43#j, the DNS response notifying the address of the CDN cache server 42#j.

At the operation AE, the S-GW 11#b judges whether to set a new channel for the mobile station 31#1 to access the CDN cache server 42. For example, when the results of the DNS responses, which are received at the operations AC and AD, differ, the S-GW 11#b judges that the CDN cache server 42#j is better than the CDN cache server 42#i routed through the default channel. In this case, the S-GW 11#b judges to set a new channel. If the results of the DNS responses, which are received at the operations AC and AD, are the same, the S-GW 11#b judges not to set a new channel.

When setting a new channel, at the operation AF, the S-GW 11#b sends an address conversion device route communication request to the channel control device 15. The address conversion device route communication request may include identifiers of the S-GW 11#b, the P-GW 12#b routing the DNS response notifying the address of the CDN cache server 42#j, and the external network 40#1 to which the P-GW 12#b is connected.

At the operation AG, the channel control device 15 uses these identifiers as the basis to select an address conversion device 14#x.

The channel control device 15 sends a request acknowledgement response to the S-GW 11#b. When an address conversion device 14 is not selected, the channel control device 15 sends a request non-acknowledgement response to the S-GW 11#b.

If receiving a request acknowledgement response, at the operation AH, the S-GW 11#b sets the flow processing information for transferring the additional flow by the first channel 21#1 in accordance with the selected address conversion device 14#x.

At the operation AI, the packets, which are transmitted from the mobile station 31#1 to the CDN cache server 42#j, are transferred routed through the first channel 21#1 to the address conversion device 14#x. At the operation AJ, the address conversion device 14#x first detects, at the first channel 21#1, the packets which are sent from the mobile station 31#1 and addressed to the CDN cache server 42#j. The address conversion device 14#x acquires the external address corresponding to the first channel 21#1 from the resource management table 110. The address conversion device 14#x sets the acquired address as the external address of the mobile station 31#1.

At the operation AK, the packets are transferred to the P-GW 12#b routed through the second channel 22#x corresponding to the first channel 21#1 and are transferred to the CDN cache server 42#j routed through the P-GW 12#b.

After that, the S-GW 11#b performs processing for branching and integrating the additional flow. At the operation AL, the S-GW 11#b transfers packets of the flow by the default channel, for which a branched flow processing table 103 and integrated flow processing table 104 are not set.

On the other hand, at the operation AM, the S-GW 11#b branches the packets of the additional flow to the first channel 21#1, based on the branched flow processing table 103. The address conversion device 14#x converts the source address of the packets of the uplink additional flow to an external address and transfers them by the second channel 22#x corresponding to the first channel 21#1.

The P-GW 12#b identifies the second channel 22#x for transferring the packets, based on the destination address of the downlink additional flow. An address region of the packets, which are transferred by the second channel 22, is determined for each second channel 22. The P-GW 12#b identifies the second channel 22 for transferring the packets, based on at which address region the destination address of the downlink packets is in.

If the address conversion device 14#x receives packets routed through the second channel 22#x, it converts the destination address of the packets from an external address to an internal address of the mobile station 31#1. The address conversion device 14#x transfers the packets to the S-GW 11#b routed through the first channel 21#1 which corresponds to the second channel 22#x. The S-GW 11#b identifies the base station which transfers the packets to the mobile station 31#1, based on the integrated flow processing table 104 and the destination address of the packets, and integrates them with the packets to be sent to the mobile station 31#1 routed through the default channel, and sends the result to the base station.

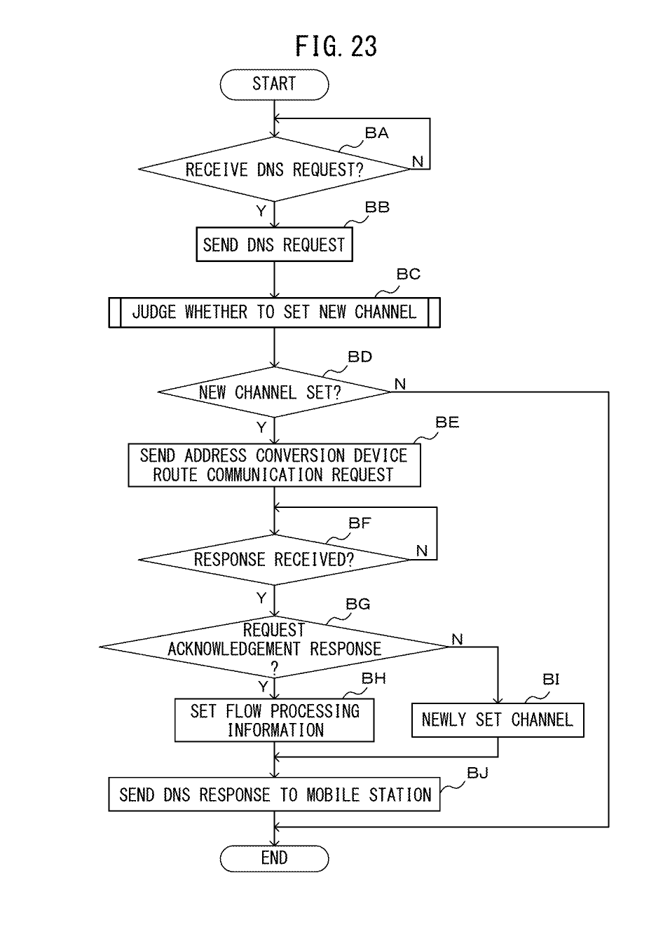

Next, the operations of the individual component elements when setting a new channel will be explained. FIG. 23 is an explanatory view of one example of a new channel setting operation at the S-GW 11#b. At the operation BA, the communication data processing unit 51 judges if it has received a DNS request of the CDN cache server 42 from the mobile station 31#1 routed through the default channel. If the DNS request was received (operation BA: Y), the operation proceeds to the operation BB. If no DNS request was received (operation BA: N), the operation returns to the operation BA.

At the operation BB, the replacement/new channel setting management unit 54 makes the communication data processing unit 51 send the DNS request. The communication data processing unit 51 sends the DNS request to another P-GW 12#b in addition to the P-GW 12#a which is connected to the mobile station 31#1 by the default channel.

At the operation BC, the replacement/new channel setting management unit 54 receives the DNS response routed through the P-GW's 12#a and 12#b. The replacement/new channel setting management unit 54 judges, based on the results of the DNS response, whether to set a new channel for the mobile station 31#1 to access the CDN cache server 42#j.

When the DNS responses received from the P-GW's 12#a and 12#b show the addresses of different CDN cache servers 42#i and 42#j, the replacement/new channel setting management unit 54 determines to set a new channel (operation BD: Y). In this case, the replacement/new channel setting management unit 54 selects the CDN cache server 42#j, as the access destination of the mobile station 31#1, the address of which is indicated by the DNS response received from the P-GW 12#b. After that, the operation proceeds to the operation BE. When not setting a new channel (operation BD: N), the new channel setting operation is ended.

At the operation BE, the address conversion service control unit 55 sends the address conversion device route communication request to the channel control device 15.

At the operation BF, the address conversion service control unit 55 judges whether it has received a response to the address conversion device route communication request. If it has received a response (operation BG: Y), the operation proceeds to the operation BG. If it has not received a response (operation BG: N), the operation returns to the operation BF.

At the operation BG, the address conversion service control unit 55 judges if the received response is a request acknowledgement response. If the response is a request acknowledgement response (operation BG: Y), the operation proceeds to the operation BH. If the response is a request non-acknowledgement response (operation BG: N), the operation proceeds to the operation BI.

At the operation BH, the address conversion service control unit 55 generates entries of the branched flow processing table 103 and the integrated flow processing table 104 for the additional flow. Due to the generation of the entries, the first channel 21 by which the S-GW 11#b transfers the flow is set. After that, the operation proceeds to the operation BJ.

At the other operation BI, the replacement/new channel setting management unit 54 starts up the routine for setting a new channel between the S-GW 11#b and the P-GW 12#b. Due to this routine, a new external address of the mobile station 31#1 is issued from the P-GW 12#b for the additional flow and a tunnel is formed between the S-GW 11#b and the P-GW 12#b.

At the operation BJ, the replacement/new channel setting management unit 54 sends a DNS response to the mobile station 31#1, which designates the address of the CDN cache server 42#j which is selected as the access destination.

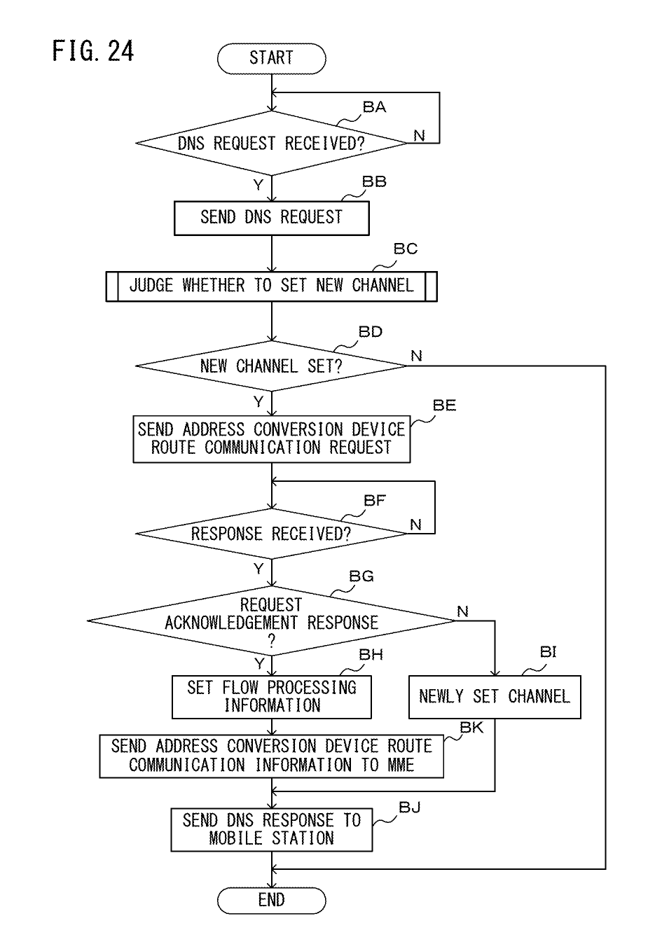

Note that, when the S-GW 11, to which the mobile station 31#1 is connected, is changed due to a HO of the mobile station 31#1, information relating to the additional flow may be notified to the MME 13 for setting the flow processing information in the S-GW 11 to which the mobile station 31#1 is connected after HO. FIG. 24 is an explanatory view of a modification of the new channel setting operation at the S-GW 11#b.

At the operation BK, the address conversion service control unit 55 sends the address conversion device route communication information to the MME 13. The MME 13 prepares an entry which stores the address conversion device route communication information in the address conversion device route flow table 114.

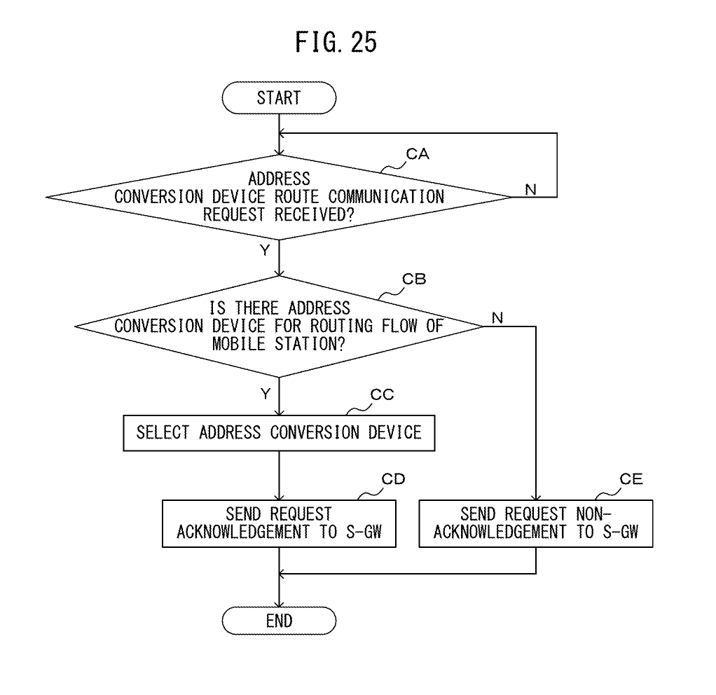

FIG. 25 is an explanatory view of one example of the new channel setting operation at the channel control device 15. At the operation CA, the communication setting signaling processing unit 61 judges if it has received an address conversion device route communication request from an S-GW 11. If it has received an address conversion device route communication request (operation CA: Y), the operation proceeds to the operation CB. If it has not received an address conversion device route communication request (operation CA: N), the operation returns to the operation CA.

At the operation CB, the address conversion device resource management unit 62 judges if there is an address conversion device 14 for routing the additional flow. If there is an address conversion device 14 for routing the additional flow (operation CB: Y), the operation proceeds to the operation CC. If there is no address conversion device 14 for routing the additional flow (operation CB: N), the operation proceeds to the operation CE.

When there are a plurality of address conversion devices 14 for routing the additional flow, at the operation CC, the address conversion device resource management unit 62 follows predetermined selection criteria to select one. At the operation CD, the address conversion device resource management unit 62 sends the request acknowledgement response to the S-GW 11#b. The request acknowledgement response includes information which designates the selected address conversion device 14#x.

At the other operation CE, the address conversion device resource management unit 62 sends a request non-acknowledgement response to the S-GW 11#b.

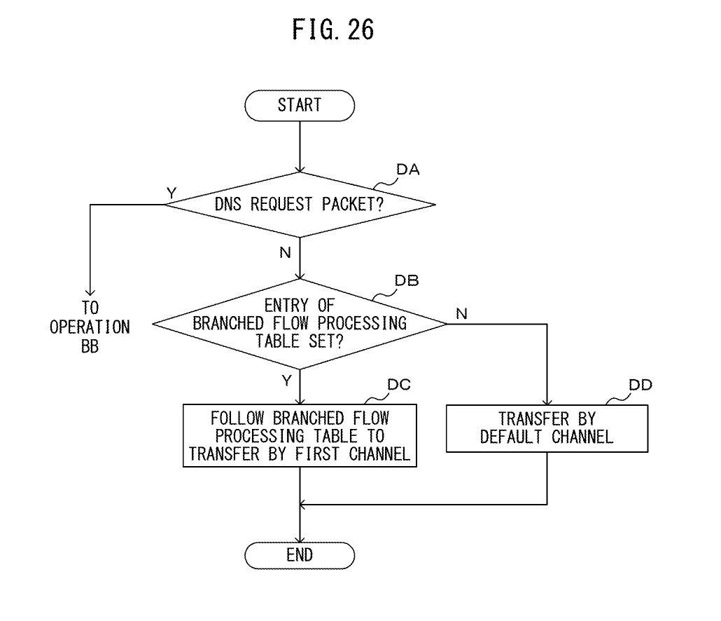

FIG. 26 is an explanatory view of one example of the operation of the S-GW 11#b when receiving uplink packets. At the operation DA, the communication data processing unit 51 judges if the received packets are a DNS request. If the received packets are a DNS request (operation DA: Y), the operation proceeds to the operation BB of FIG. 23. If the received packets are not a DNS request (operation DA: N), the operation proceeds to the operation DB.

At the operation DB, the communication data processing unit 51 judges if an entry of the flow of received packets has been set at the branched flow processing table 103. When an entry has been set (operation DB: Y), the operation proceeds to the operation DC. When no entry has been set (operation DB: N), the operation proceeds to the operation DD.

At the operation DC, the communication data processing unit 51 transfers the received packets by the first channel 21#1 which is designated in accordance with the branched flow processing table 103. At the operation DD, the communication data processing unit 51 transfers the packets received by the default channel.

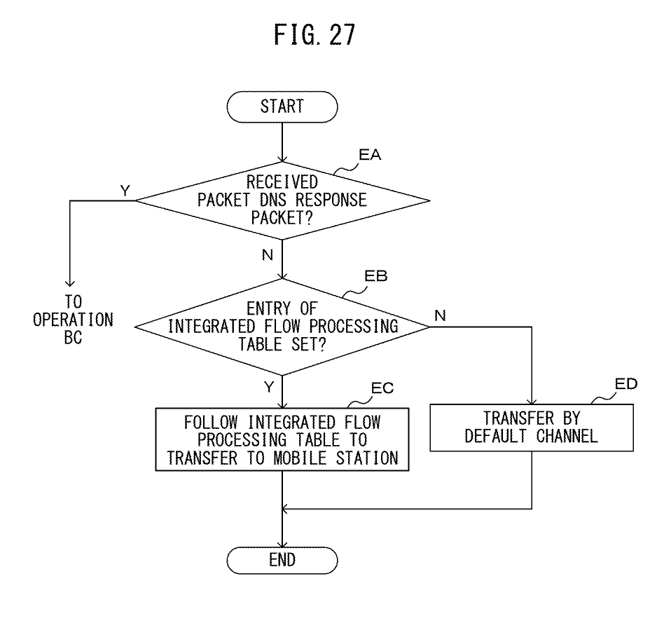

FIG. 27 is an explanatory view of one example of the operation of the S-GW 11#b when receiving downlink packets. At the operation EA, the communication data processing unit 51 judges if the received packets are a DNS response. If the received packets are a DNS response (operation EA: Y), the operation proceeds to the operation BC of FIG. 23. If the received packets are not a DNS response (operation EA: N), the operation proceeds to the operation EB.

At the operation EB, the communication data processing unit 51 judges if an entry of the flow of packets received has been set in the integrated flow processing table 104. If an entry has been set (operation EB: Y), the operation proceeds to the operation EC. When no entry has been set (operation EB: N), the operation proceeds to the operation ED.

At the operation EC, the communication data processing unit 51 transfers the received packets to the mobile state 31#1 which is designated in accordance with the integrated flow processing table 104. At the operation ED, the communication data processing unit 51 transfers the packets received by the default channel.

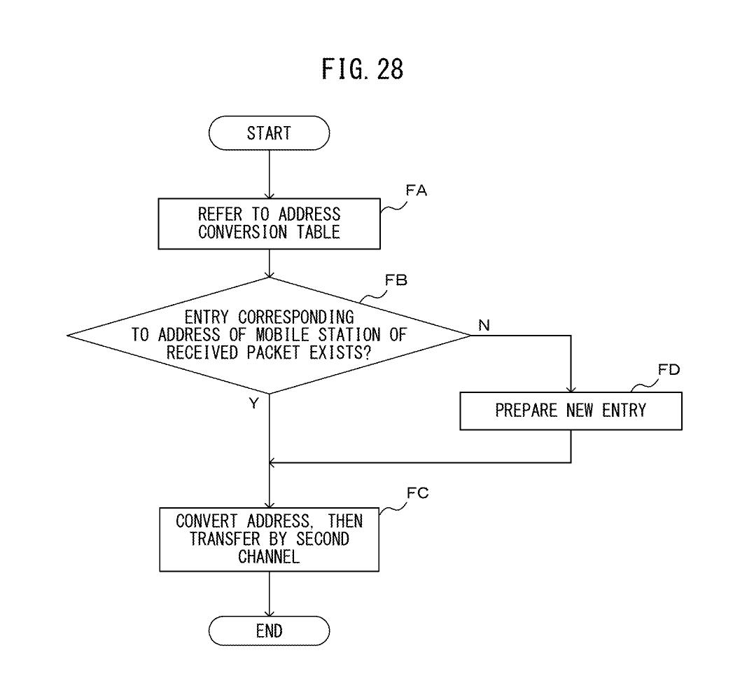

FIG. 28 is an explanatory view of a first example of the operation of the address conversion device 14#x when receiving uplink packets. At the operation FA, the communication data processing unit 71 refers to the address conversion table 108 corresponding to the first channel 21#1 over which the packets were received.

At the operation FB, the communication data processing unit 71 judges if there is an entry corresponding to the address of the mobile station 31#1 of the received packets in the address conversion table 108. If there is corresponding entry at the address conversion table 108 (operation FB: Y), the operation proceeds to the operation FC. If there is no corresponding entry in the address conversion table 108 (operation FB: N), the operation proceeds to the operation FD.

At the operation FC, the communication data processing unit 71 converts the address of the mobile station 31#1 of the received packets to an external address in accordance with the address conversion table 108. The communication data processing unit 71 transfers the received packets to the second channel 22#x in accordance with the address conversion table 108.

At the operation FD, the conversion table management unit 72 acquires an external address from the unused resources for the first channel 21#1 in the resource management table 110. Further, the conversion table management unit 72 refers to the second relay table 109 and determines the second channel 22#x corresponding to the first channel 21#1.

The conversion table management unit 72 generates an entry, at the address conversion table 108 corresponding to the first channel 21#1, which converts the address of the received packets to an external address which is acquired from the resource management table 110. The conversion table management unit 72 registers the second channel 22#x in this entry. After that, the operation proceeds to the operation FC.

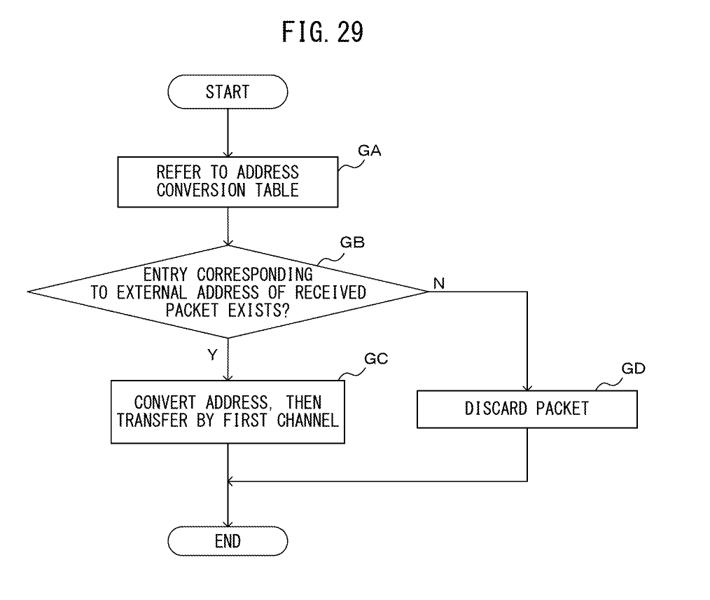

FIG. 29 is an explanatory view of one example of the address conversion device 14#x when receiving the downlink packets. At the operation GA, the communication data processing unit 71 refers to the address conversion table 108.

At the operation GB, the communication data processing unit 71 judges if there is an entry corresponding to the external address of the mobile station 31#1 of the received packets in the address conversion table 108. If there is a corresponding external entry in the address conversion table 108 (operation GB: Y), the operation proceeds to the operation GC. If there is no corresponding entry in the address conversion table 108 (operation GB: N), the operation proceeds to the operation GD.

At the operation GC, the communication data processing unit 71 specifies the internal address of the mobile station 31#1 and the first channel 21#1 corresponding to the second channel 22#x, based on the address conversion table 108. The communication data processing unit 71 converts the destination address of the received packets to an internal address. The communication data processing unit 71 transfers the received packets by the specified first channel 21#1. At the operation GD, the communication data processing unit 71 discards the received packets.

3.2. Channel Changing Operation 1

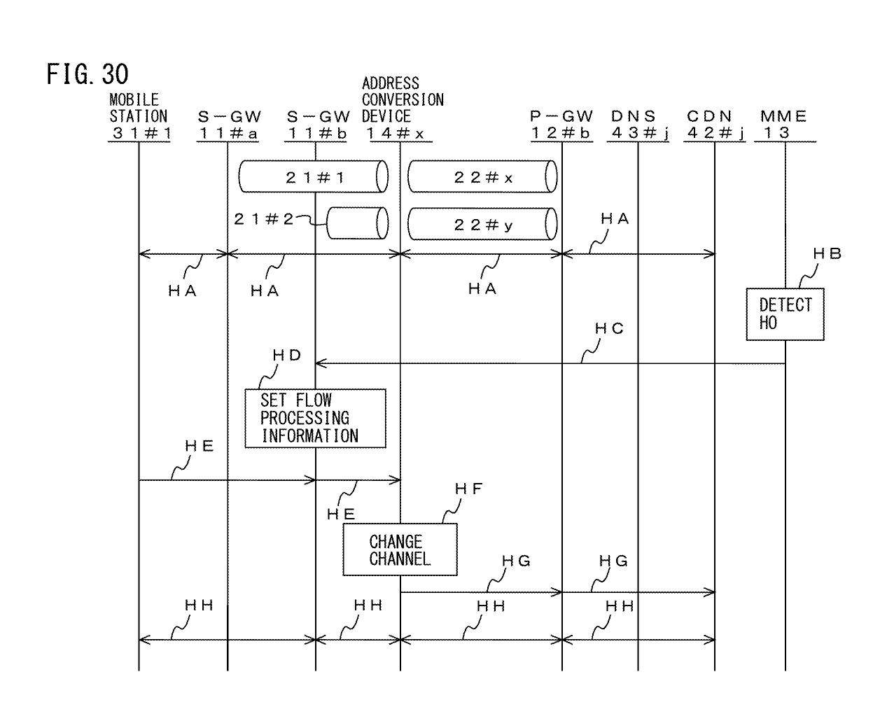

FIG. 30 is an explanatory view of a first example of a channel changing operation. The overall operation when HO of the mobile station 31#1 causes the S-GW, to which the mobile station 31#1 is connected, to change from the S-GW 11#a to the S-GW 11#b, will be explained.

Between the P-GW 12#b and the address conversion device 14#x, second channels 22#x and 22#y are set. Between the S-GW 11#a and the address conversion device 14#x, a first channel 21#1 corresponding to the second channel 22#x is set. Between the S-GW 11#b and the address conversion device 14#x, a first channel 21#2 corresponding to the second channel 22#y is set. The second channel 22#x and 22#y are second channels which are connected to the same external network 40#1 through the P-GW 12#b.

At the operation HA, the mobile station 31#1 accesses the CDN cache server 42#j routed through the S-GW 11#a, first channel 21#1, address conversion device 14#x, second channel 22#x, and PG-W#12#b.

If HO of the mobile station 31#1 causes the S-GW, to which the mobile station 31#1 is connected, to change from the S-GW 11#a to the S-GW 11#b, at the operation HB, the MME 13 detects the HO of the mobile station 31#1.

At the operation HC, the MME 13 sends the address conversion device route communication information of the mobile station 31#1 to the S-GW 11#b. The MME 13 may also add the address conversion device route communication information to the HO procedure message.

At the operation HD, the S-GW 11#b sets the flow processing information for transferring the flow with the mobile station 31#1 by the first channel 21#2, based on the address conversion device route communication information.

At the operation HE, the packets, which are sent from the mobile station 31#1 to the CDN cache server 42#j, are transferred to the address conversion device 14#x routed through the first channel 21#2. At the operation HF, the address conversion device 14#x first detects packets of the additional flow of the mobile station 31#1 at the first channel 21#2.

The address conversion device 14#x detects an entry of the address of the mobile station 31#1 of the destination of the received packets from the group of address conversion tables 108 of the first channels 21 which transfer additional flow to the the P-GW 12#b and external network 40#1 in the same way as the first channel 21#2.

The address conversion device 14#x moves the detected entry to the address conversion table 108 corresponding to the first channel 21#2. As a result, the channel, over which the downlink additional flow is transferred, is changed from the first channel 21#1 to the first channel 21#2.

The packets which are detected at the operation HF are transferred, at the operation HG, to the P-GW 12#b routed through the second channel 22#x and are transferred to the CDN cache server 42#j routed through the P-GW 12#b.

At the operation HH after that, the S-GW 11#b branches the packets of the additional flow to the first channel 21#2, based on the flow processing information. The address conversion device 14#x transfers the uplink packets, which are sent by the first channel 21#2, by the second channel 22#x.

If the address conversion device 14#x receives downlink packets of the additional flow routed through the second channel 22#x, it transfers, based on the address conversion table 108, the packets to the S-GW 11#b routed through the first channel 21#2. The S-GW 11#b integrates the received packets with the packets which are sent to the mobile station 31#1 routed through the default channel, and sends the result to the base station.

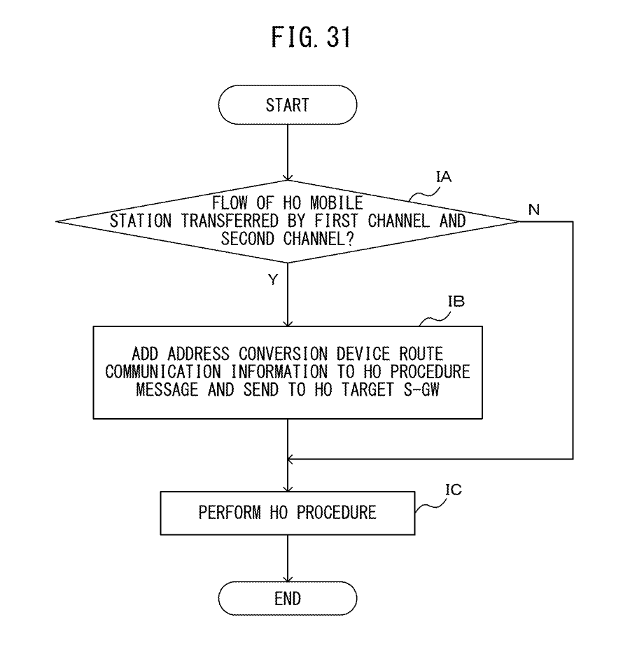

The operations of the individual component elements in the case of the first example of change of the channel, will be explained next. FIG. 31 is an explanatory view of one example of the operation of the MME 13 at the time of HO. At the operation IA, the address conversion service control unit 95 judges if the additional flow of the mobile station 31, which performs the HO, is being transferred by the first channel 21 and second channel 22.

When the flow is being transferred by the first channel 21 and second channel 22 (operation IA: Y), the operation proceeds to the operation IB. When the flow is not being transferred by the first channel 21 and second channel 22 (operation IA: N), the operation proceeds to the operation IC.

At the operation IB, the address conversion service control unit 95 adds the address conversion device route communication information of the mobile station 31#1 to the HO procedure message and sends the result to the HO target S-GW 11#b. After that, the operation proceeds to the operation IC. At the operation IC, the core network service control unit 94 performs the HO procedure.

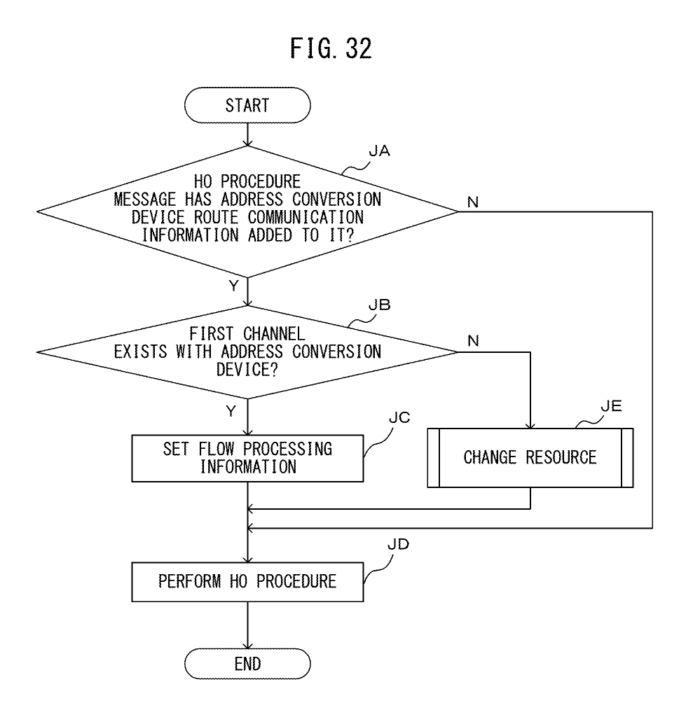

FIG. 32 is an explanatory view of a first example of the operation of the S-GW 11#b at the time of HO. At the operation JA, the address conversion service control unit 55 judges if the address conversion device route communication information of the mobile station 31 is added to the HO procedure message which is received from the MME 13. When the address conversion device route communication information is added to the HO procedure message (operation JA: Y), the operation proceeds to the operation JB. When the address conversion device route communication information is not added to the HO procedure message (operation JA: N), the operation proceeds to the operation JD.

At the operation JB, the address conversion service control unit 55 judges, based on the first channel setting table 101, if a first channel 21 has been set with the address conversion device 14#x which is designated by the address conversion device route communication information. If a first channel 21 has been set (operation JB: Y), the operation proceeds to the operation JC. If a first channel 21 has not been set (operation JB: N), the operation proceeds to the operation JE.

At the operation JC, the address conversion service control unit 55 prepares an entry of the branched flow processing table 103 for transmitting the uplink additional flow by the first channel 21#2 with the address conversion device 14#x. The address conversion service control unit 55 generates an entry of the integrated flow processing table 104 for transmitting the downlink additional flow by a first channel 21#2 with the address conversion device 14#x.

After that, at the operation JD, the core network service control unit 53 performs the HO procedure.

When a first channel 21 is not set between the address conversion device 14, which is designated by the address conversion device route communication information and the G-SW 11#b (operation JB: N), the additional flow cannot be sent by the first channel 21.

In this case, at the operation JE, the address conversion service control unit 55 starts the resource change processing. After the operation JE, the operation proceeds to the operation JD.

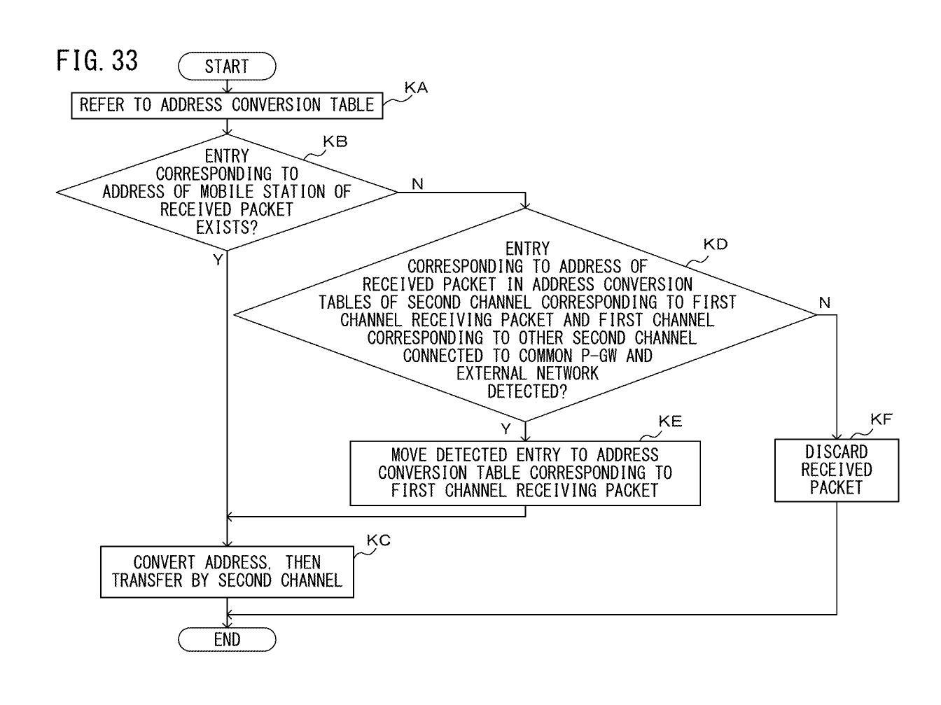

FIG. 33 is an explanatory view of a second example of the address conversion device 14#x when receiving uplink packets. At the operation KA, the communication data processing unit 71 refers to the address conversion table 108 corresponding to the first channel 21#2 which received the packets.

At the operation KB, the communication data processing unit 71 judges if there is an entry corresponding to the address of the mobile station 31#1 of the received packets in the address conversion table 108. If there is a corresponding entry in the address conversion table 108 (operation KB: Y), the operation proceeds to the operation KC. If there is no corresponding entry in the address conversion table 108 (operation KB: N), the operation proceeds to the operation KD.

At the operation KC, the communication data processing unit 71 follows the address conversion table 108 to convert the address of the mobile station 31#1 of the received packets to an external address. The communication data processing unit 71 follows the address conversion table 108 to transfer the received packets by the second channel 22#x.

At the operation KD, the conversion table management unit 72, in the same way as the first channel 21#2, refers to the group of the address conversion tables 108 of the first channels 21 which transfer additional flows to the P-GW 12 and external network 40. The communication data processing unit 71 detects an entry of address of the mobile station 31#1 from the group. When the entry is detected (operation KD: Y), the operation proceeds to the operation KE. When an entry is not detected (operation KD: N), the operation proceeds to the operation KF.

At the operation KE, the conversion table management unit 72 moves the detected entry to the address conversion table 108 corresponding to the first channel 21#2. After that, the operation proceeds to the operation KC. At the other operation KF, the communication data processing unit 71 discards the received packet.

3.3. Channel Changing Operation 2

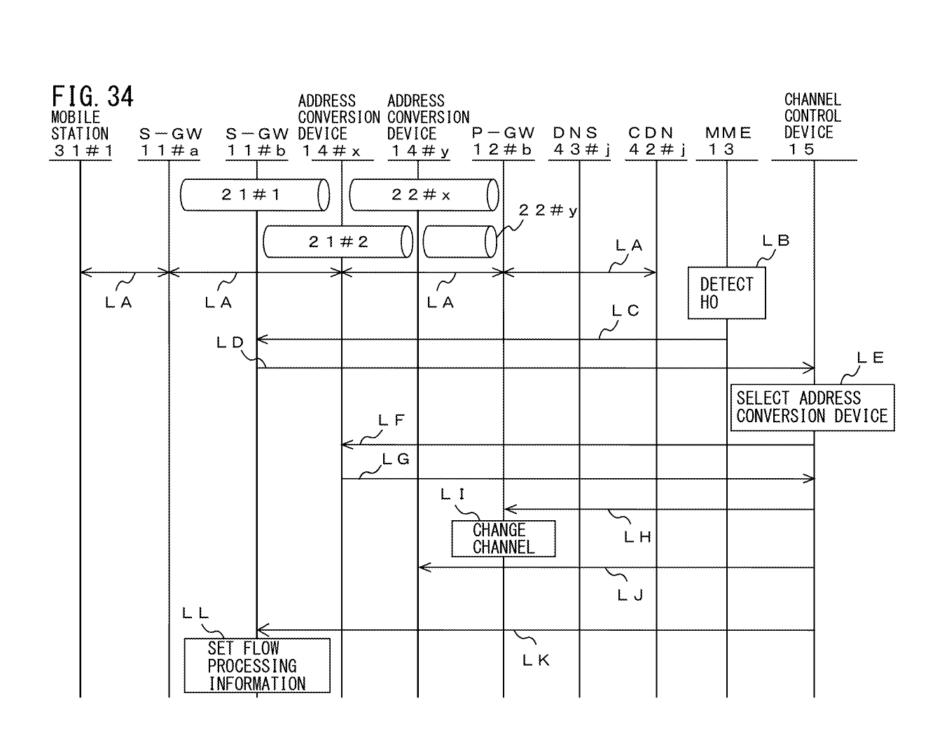

FIG. 34 is an explanatory view of a second example of a channel changing operation. In this example, the case is assumed, where the address conversion device 14#x, which had transferred the additional flow routed through the first channel 21#1 before HO, does not transfer the additional flow with the S-GW 11#b, to which the mobile station 31#1 is connected after HO.

The second channel 22#x is a second channel which is set between the P-GW 12#b and the address conversion device 14#x. The second channel 22#y is a second channel which is set between the P-GW 12#b and the address conversion device 14#y. The second channels 22#x and 22#y are second channels which are connected through the P-GW 12#b to the same external network 40#1.

The first channel 21#1 is a first channel which is set between the S-GW 11#a and the address conversion device 14#x. The first channel 21#1 corresponds to the second channel 22#x. The first channel 21#2 is a first channel which is set between the S-GW 11#b and the address conversion device 14#y. The first channel 21#2 corresponds to the second channel 22#y.

At the operation LA, the mobile station 31#1 accesses the CDN cache server 42#j routed through the S-GW 11#a, first channel 21#1, address conversion device 14#x, second channel 22#x, and PG-W12#b.

Due to a HO of the mobile station 31#1, if the S-GW, to which the mobile station 31#1 is connected, is changed from S-GW 11#a to S-GW 11#b, at the operation LB, the MME 13 detects the HO of the mobile station 31#1.

At the operation LC, the MME 13 sends the address conversion device route communication information of the mobile station 31#1 to the S-GW 11#b of the HO target. When the address conversion device 14#x, which is designated by the address conversion device route communication information, does not transfer the additional flow with the S-GW 11#b, at the operation LD, the S-GW 11#b starts the resource change processing. The S-GW 11#b sends the resource request to the channel control device 15.

At the operation LE, the channel control device 15 selects the address conversion device 14#y, which transfers the additional flow, in response to the resource request. At the operation LF, the channel control device 15 sends a conversion information continuation instruction to the address conversion device 14#x. At the operation LG, the address conversion device 14#x sends the external address, which is allocated to the mobile station 31#1, to the channel control device 15.

At the operation LH, the channel control device 15 notifies the external address of the mobile station 31#1 to the P-GW 12#b. The channel control device 15 notifies, to the P-GW 12#b, the second channel 22#y between the address conversion device 14#y and the P-GW 12#b which transmits the communication flow with the external network 40#1.

At the operation LI, the P-GW 12#b generates an entry, at the downlink transfer table 111, which individually designates a destination of the downlink additional flow for the second channel 22#y.

At the operation LJ, the channel control device 15 notifies the address conversion device 14#y of the address of the mobile station 31#1 and the external address of the mobile station 31#1. When the address conversion device 14#y first receives packets of the uplink additional flow of the mobile station 31#1 at the first channel 21#2, it registers, at the address conversion table 108, the external address which is received from the channel control device 15.

At the operation LK, the channel control device 15 sends, to the S-GW 11#b, a request acknowledgement response to the resource request. At the operation LL, the S-GW 11#b sets flow processing information for transfer of the additional flow by the first channel 21#2 in accordance with the address conversion device 14#y which is notified by the request acknowledgement response.

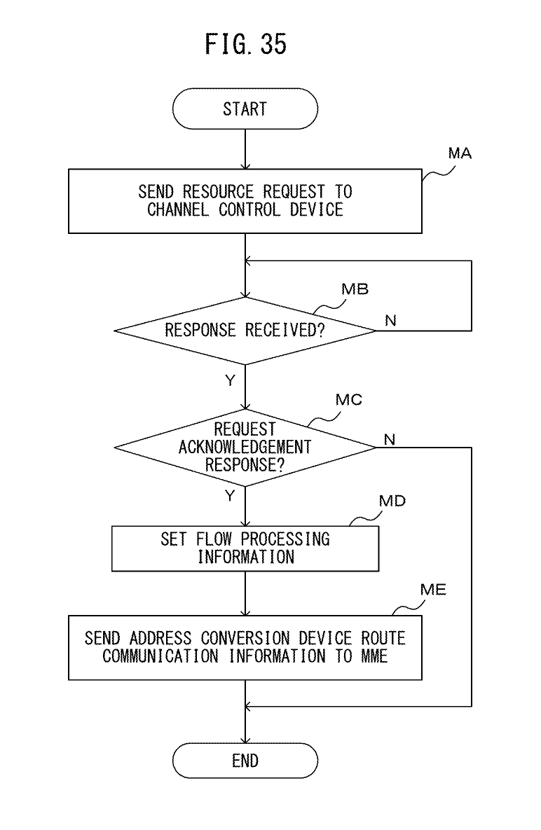

The operations of the individual component elements in the case of the second example of change of the channel, will be explained. FIG. 35 is an explanatory view of one example of the S-GW 11#b in resource change processing. At the operation MA, the address conversion service control unit 55 sends a resource request to the channel control device 15.

At the operation MB, the address conversion service control unit 55 judges whether it has received a response to the resource request. If receiving a response (operation MB: Y), the operation proceeds to the operation MC. If not receiving a response (operation MB: N), the operation returns to the operation MB.

At the operation MC, the address conversion service control unit 55 judges if the received response is a request acknowledgement response. If the response is the request acknowledgement response (operation MC: Y), the operation proceeds to the operation MD. If the response is a request non-acknowledgement response (operation MC: N), the resource change processing is ended.

At the operation MD, the address conversion service control unit 55 sets the flow processing information for transfer of the additional flow by the first channel 21#2 with the address conversion device 14#y which is designated by the request acknowledgement response. At the operation ME, it sends the address conversion device route communication information to the MME 13.

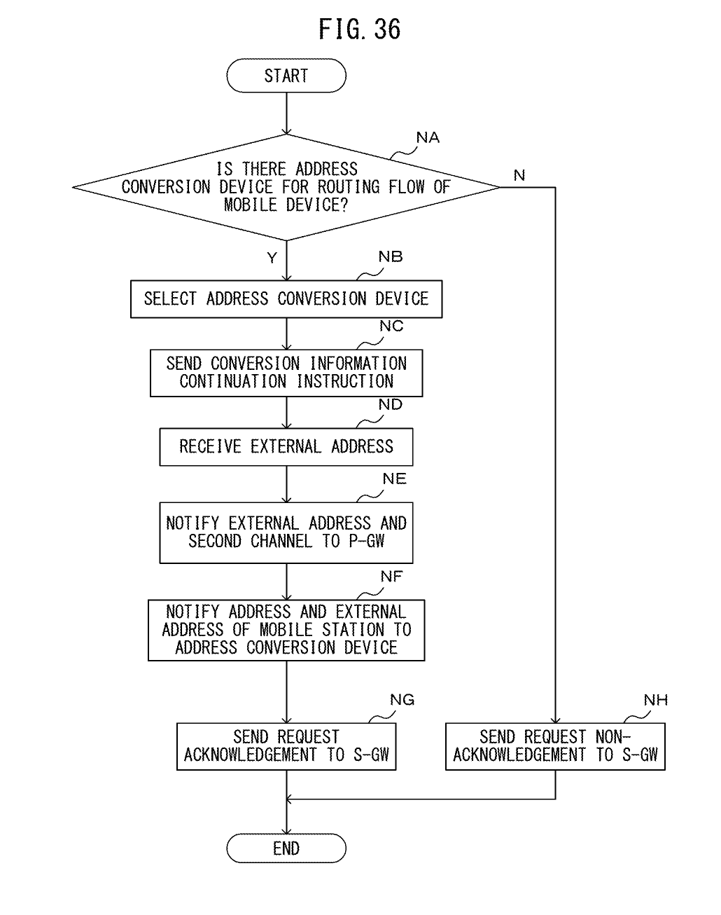

FIG. 36 is an explanatory view of a first example of the operation of the channel control device 15 in the resource change processing. At the operation NA, the address conversion device resource management unit 62 judges if there is an address conversion device 14 for routing the additional flow. If there is an address conversion device 14 for routing the additional flow (operation NA: Y), the operation proceeds to the operation NB. If there is no address conversion device 14 for routing the additional flow (operation NA: N), the operation proceeds to the operation NH.

If there are a plurality of address conversion devices 14 for routing the additional flow, at the operation NB, the address conversion device resource management unit 62 follows predetermined selection criteria to select one.

At the operation NC, the address conversion device resource management unit 62 sends to the address conversion device 14#x a conversion information continuation instruction. At the operation ND, the address conversion device resource management unit 62 receives, from the address conversion device 14#x, an external address which the address conversion device 14#x allocated to the mobile station 31#1.

At the operation NE, the address conversion device resource management unit 62 notifies the P-GW 12#b of the external address of the mobile station 31#1 and the second channel 22#y. At the operation NF, the address conversion device resource management unit 62 sends the address and external address of the mobile station 31#1 to the address conversion device 14#y which is selected at the operation NB.

At the operation NG, the address conversion device resource management unit 62 sends the request acknowledgement response to the S-GW 11#b. The request acknowledgement response includes information which designates the selected address conversion device 14#y. On the other hand, at the operation NH, the address conversion device resource management unit 62 sends a request non-acknowledgement response to the S-GW 11#b.

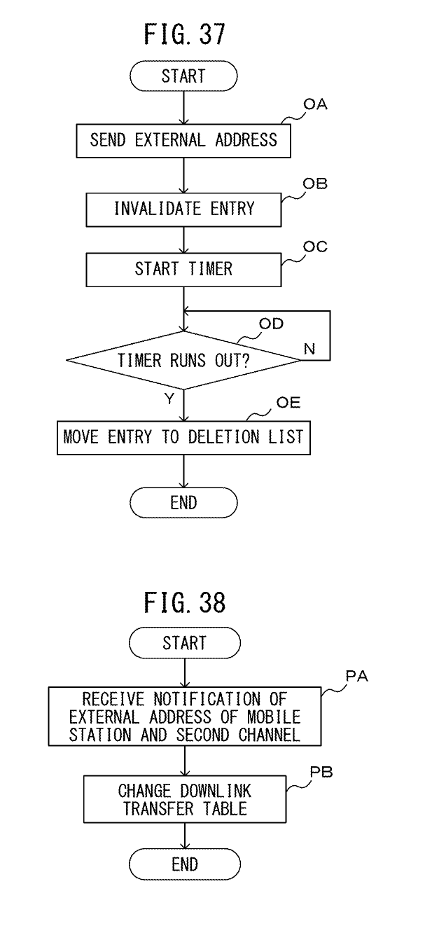

FIG. 37 is an explanatory view of one example of the operation of the address conversion device 14#x in resource change processing. If receiving a conversion information continuation instruction, at the operation OA, the address conversion service control unit 75 detects an entry of an address of the mobile station 31#1, which is designated by the conversion information continuation instruction, from the address conversion table 108. The address conversion service control unit 75 sends the external address of the mobile station 31#1, which is stored in the detected entry, to the channel control device 15.

At the operation OB, the conversion table management unit 72 invalidates the entry which is detected at the operation OA. At the operation OC, the conversion table management unit 72 starts a timer which counts a predetermined standby time.

At the operation OD, the conversion table management unit 72 judges if the timer has finished its count. If the timer has not finished its count (operation OD: Y), the operation returns to the operation OD. If the timer has finished its count (operation OD: N), the operation returns to the operation OE. At the operation OE, the conversion table management unit 72 stores the invalidated entry in a predetermined deletion list. When the number of registered items in the deletion list exceeds a predetermined number, the entries which are registered in the deletion list are deleted.

FIG. 38 is an explanatory view of a first example of the operation of the P-GW 12#b in resource change processing. At the operation PA, the core network address conversion mechanism path management unit 85 receives from the channel control device 15 a notification of the external address of the mobile station 31#1 and the second channel 22#y.

At the operation PB, the core network address conversion mechanism path management unit 85 changes the destination of the downlink additional flow, which is designated by the downlink transfer table 111, to the second channel 22#y.

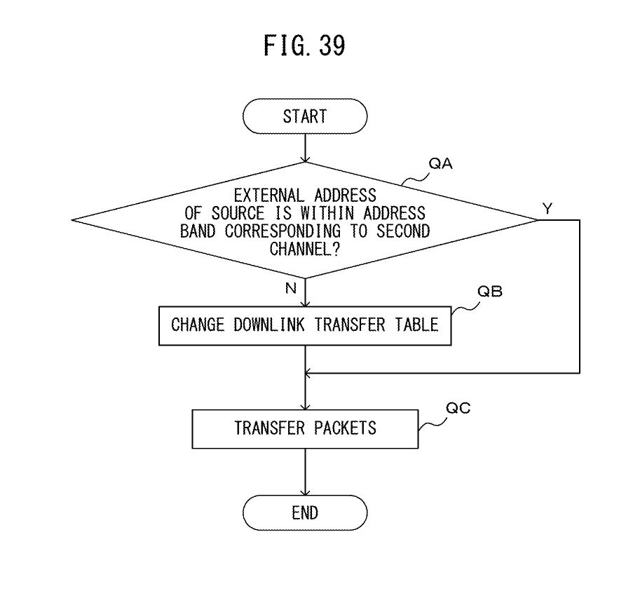

FIG. 39 is an explanatory view of a second example of the operation of the P-GW 12#b in resource change processing. In this example, the P-GW 12#b generates an entry in the downlink transfer table 111 by detection of uplink packets of the mobile station 31#1 which are sent by the second channel 22#y.

At the operation QA, if the communication data processing unit 81 detects uplink packets at the second channel 22, the core network address conversion mechanism path management unit 85 refers to the address region which is determined in the uplink transfer table 112 for the second channel 22. The core network address conversion mechanism path management unit 85 judges if the external address of the detected packets is an address in the address region. If the external address is an address in the address region (operation QA: Y), the operation proceeds to the operation QC. If the external address is not in the address region (operation QA: N), the operation proceeds to the operation QB.

At the operation QB, the core network address conversion mechanism path management unit 85 changes the destination of the downlink additional flow, which is designated by the downlink transfer table 111, to the second channel 22#y. After that, the operation proceeds to the operation QC. At the operation QC, the communication data processing unit 81 sends the uplink packets to the external network 40#1.

3.4. Channel Change Operation 3

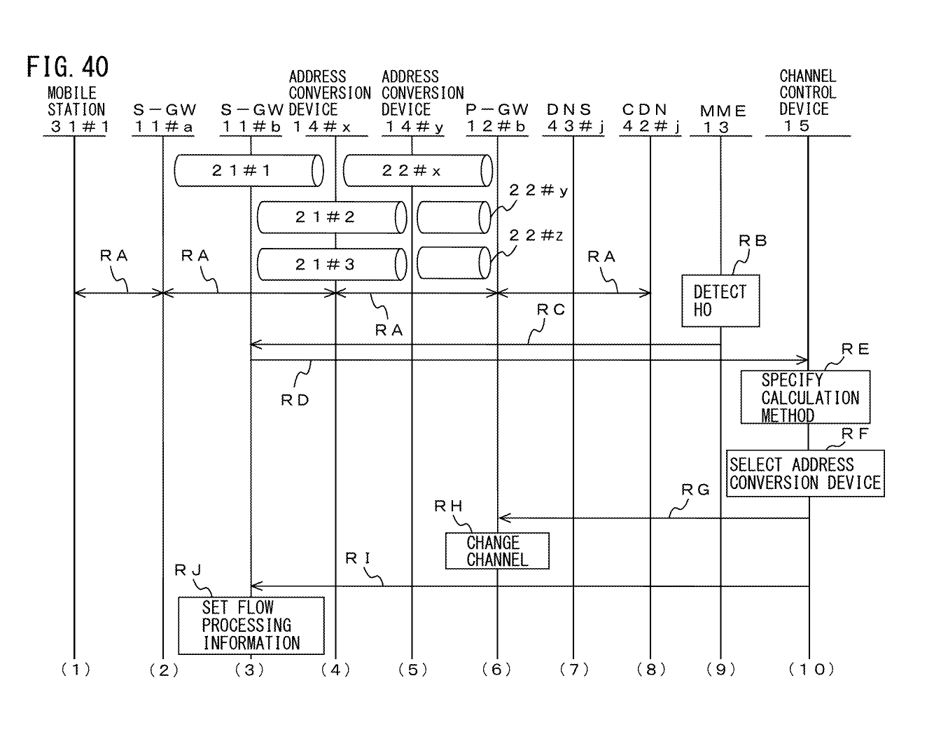

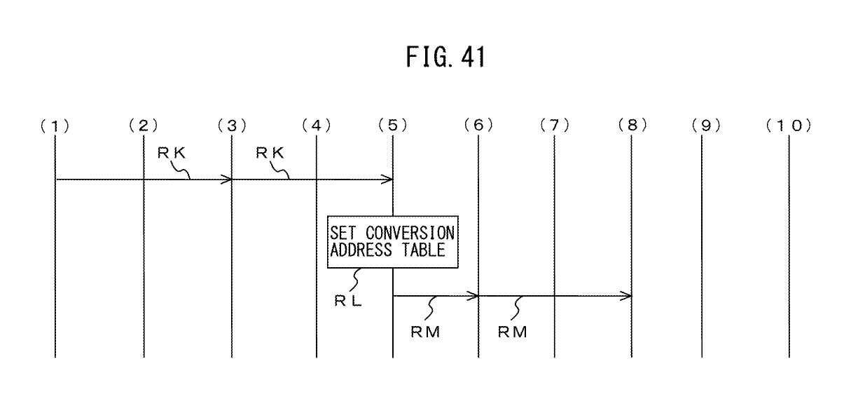

FIG. 40 and FIG. 41 are explanatory views of a third example of a channel change operation. In the same way as the above second example, the case is assumed, where the address conversion device 14#x, which had transferred the additional flow routed through the first channel 21#1 before HO, does not transfer the additional flow with the S-GW 11#b, which the mobile station 31#1 is connected to, after HO.

The channel control device 15 of the present embodiment need not receive the external address of the mobile station 31#1 from the address conversion device 14#x. The address conversion device 14 can use a predetermined calculation method, which is respectively linked with each first channel 21, as the basis to calculate the external address which is allocated to the mobile station 31#1. The channel control device 15 and the address conversion device 14#y, which newly transfers the additional flow, use the same calculation method to calculate the same address as the external address which the address conversion device 14#x had allocated. By eliminating the sending and receiving of addresses between the channel control device 15 and the address conversion device 14, the amount of signals for changing the channel can be reduced.

The second channel 22#x is a second channel which is set between the P-GW 12#b and the address conversion device 14#x. The second channels 22#y and 22#z are second channels which are set between the P-GW 12#b and the address conversion device 14#y. The second channels 22#x, 22#y, and 22#z are second channels which are connected through the P-GW 12#b to the same external network 40#1.

The first channel 21#1 is the first channel which is set between the S-GW 11#a and the address conversion device 14#x. The first channel 21#1 corresponds to the second channel 22#x. The first channels 21#2 and 21#3 are first channels which are set between the S-GW 11#b and the address conversion device 14#y. The first channels 21#2 and 21#3 correspond to the second channels 22#y and 22#z.

The operation up to the operations RA to RD is similar to the operation up to the operations LA to LD which were explained referring to FIG. 34. At the operation RE, the channel control device 15 specifies the calculation method corresponding to the first channel 21#1.

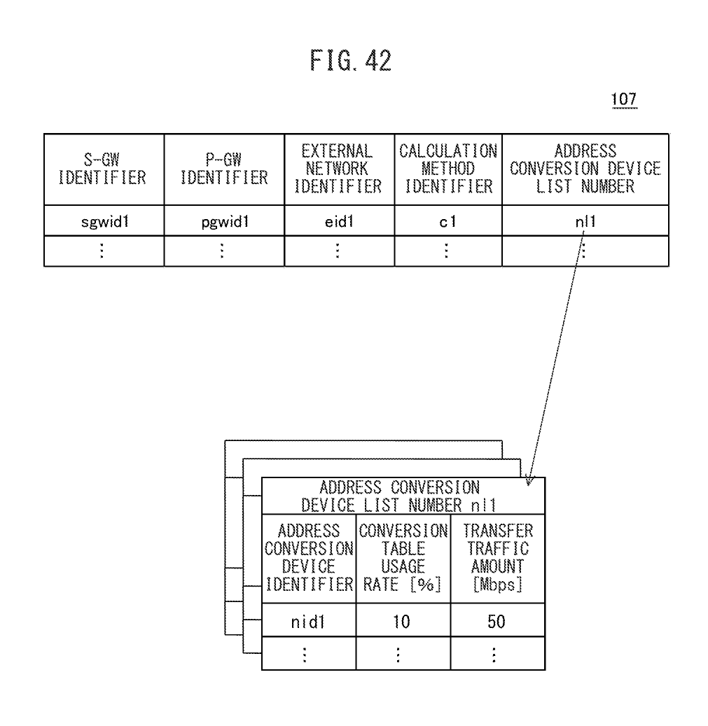

For example, the calculation method may be set by the second channel setting table 107. FIG. 42 is an explanatory view of a second example of a second channel setting table 107. The first table of the second channel setting table 107 is provided with the information element “calculation method identifier”.

The information element “calculation method identifier” is an identifier of the calculation method which is designated for each first channel 21 corresponding to the combination of the S-GW 11, the P-GW 12, external network 40, and address conversion device 14.

In the example of FIG. 42, a specific first channel 21 corresponds to the combination of the S-GW identifier “sgwid1”, P-GW identifier “pgwid1”, external network identifier “eid”, and address conversion device list number “n11”. The calculation method which is identified by the calculation method identifier “c1” is designated for this first channel 21.

Note that, the calculation method identifier may identify the calculation method, which is used for calculating the external address, and the usage condition when using the external address obtained by this calculation method. For example, the calculation method may use a function of the internal address of the mobile station 31 to calculate the external address. The usage condition, for example, may be a condition which relates to the rate of use of the address conversion table 108 of the address conversion device 14. For example, when the rate of use of the address conversion table 108 is less than a predetermined threshold value, the external address which the address conversion device 14 calculated may be used.

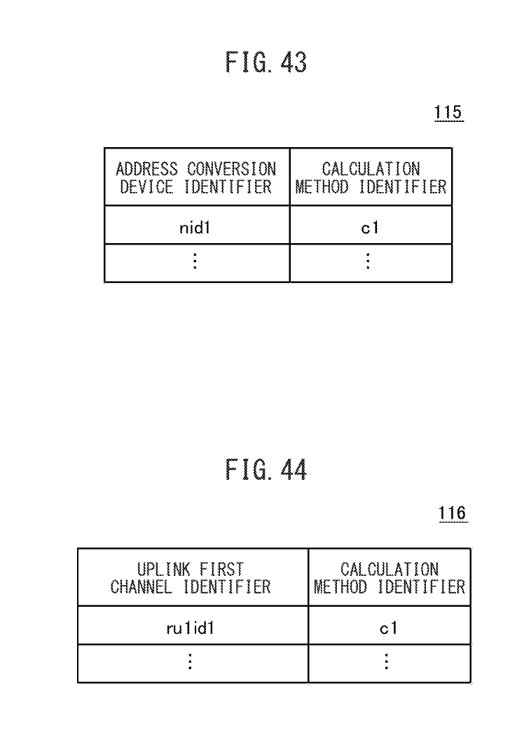

When the address conversion device 14 is provided with a plurality of packet communication ports and each is allocated an individual address conversion device identifier, the calculation method identifier may be designated for each port. The channel control device 15 may be provided with a first calculation method designation table 115 for storing the calculation method identifiers. FIG. 43 is an explanatory view of one example of the first calculation method designation table 115.

The first calculation method designation table 115 is provided with the information elements of the “address conversion device identifier” and “calculation method identifier”. The calculation method identifier identifies the external address calculation method and usage condition for each address conversion device identifier. In the example of FIG. 43, the calculation method, which is identified by the calculation method identifier “c1”, is designated for the first channel 21 which is connected to the port identified by the address conversion device identifier “nid1”.

Refer to FIG. 40 and FIG. 41. In the present embodiment, the case is assumed, where the calculation method, which is designated for the first channel 21#3 among the first channels 21#2 and 21#3 which connect the S-GW 11#b and address conversion device 14#y, is the same as the calculation method which is designated for the first channel 21#1.

At the operation RF, the channel control device 15 selects the address conversion device 14#y for transfer of the additional flow. At this time, the channel control device 15 extracts from the second channel setting table 107 an entry of the address conversion device 14 which includes all of the identifiers of the S-GW 11#b, P-GW 12#b, and external network 40#1 which are designated by the resource request.

The channel control device 15 selects from among the extracted address conversion devices 14 the address conversion device 14#y which is provided with the first channel 21#3 to which the same calculation method as the first channel 21#1 is designated by the first calculation method designation table 115.

The operation of the operations RG and RH is similar to the operation of the operations LH and LI of FIG. 34. Note that, in the same way as the second embodiment, the P-GW 12#b may generate an entry in the downlink transfer table 111 by detection of uplink packets of the mobile station 31#1 being sent by the second channel 22.

At the operation RI, the channel control device 15 sends to the S-GW 11#b a request acknowledgement response to the resource request. The request acknowledgement response may include, as information which designates the address conversion device 14#y, an address conversion device identifier. The S-GW 11#b selects, based on the address conversion device identifier, the first channel 21#3 as the first channel which transfers the additional flow. At the operation RJ, the S-GW 11#b sets the flow processing information for transferring the additional flow by the first channel 21#3 in accordance with the notified address conversion device identifier.

At the operation RK, the packets, which are sent from the mobile station 31#1 to the CDN cache server 42#j at the operation AI, are transferred to the address conversion device 14#y routed through the first channel 21#3.

At the operation RL, the address conversion device 14#y first detects packets of the additional flow at the first channel 21#3. The address conversion device 14#y calculates the external address of the mobile station 31#1, based on the calculation method which is linked with the first channel 21#3.

The address conversion device 14#y may be provided with a second calculation method designation table 116 for storing the calculation method which is designated for each first channel 21. FIG. 44 is an explanatory view of one example of the second calculation method designation table 116. The second calculation method designation table 116 is provided with the information elements of the “uplink first channel identifier” and “calculation method identifier”. The uplink first channel identifier identifies the first channel 21. The calculation method identifier identifies the external address calculation method and the usage condition for each first channel 21. In the example of FIG. 44, the calculation method, which is identified by the calculation method identifier “c1”, is designated for the first channel 21 which is identified by the uplink first channel identifier “ru1id1”. The second calculation method designation table 116 may be stored in the conversion table management unit 72.

The address conversion device 14#y registers the calculated external address in the address conversion table 108. At the operation RM, this packet is transferred to the P-GW 12#b routed through the second channel 22#z corresponding to the first channel 21#3 and is transferred to the CDN cache server 42#j routed through the P-GW 12#b.

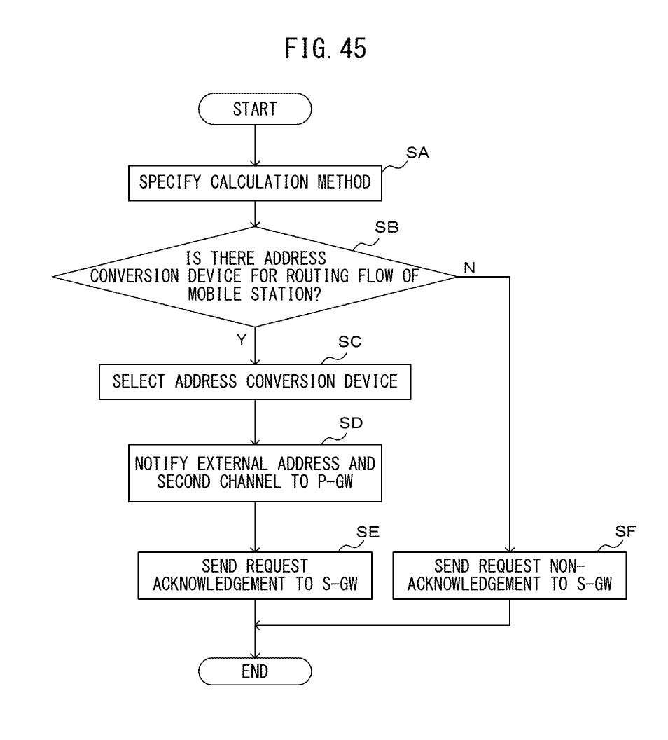

The operations of the component element in the case of the third example of change of the channel, will be explained next. FIG. 45 is an explanatory view of a second example of the operation of the channel control device 15 in resource change processing.

At the operation SA, the address conversion device resource management unit 62 specifies the calculation method corresponding to the first channel 21#1 through which the additional flow is transmitted before HO. The address conversion device resource management unit 62 uses the second channel setting table 107 and/or the first calculation method designation table 115 to specify the calculation method, which is linked with the first channel 21#1, and its usage condition.

At the operation SB, the address conversion device resource management unit 62 judges if there is an address conversion device 14 for routing the additional flow. The address conversion device resource management unit 62 extracts from the second channel setting table 107 an entry of an address conversion device 14 which includes all of the identifiers of the S-GW 11#b, P-GW 12#b, and external network 40#1, which are designated by a resource request.

The address conversion device resource management unit 62 judges if the usage condition for the calculation method is satisfied which is specified at the operation SA. The usage condition, for example, may be a condition relating to the usage rate of the address conversion table 108 of the address conversion device 14#x which is provided with the first channel 21#1. For example, the usage condition may be satisfied if the usage rate is less than a predetermined threshold value. If the usage rate is the threshold value or more, the efficiency of usage of external addresses is improved by selecting the external address to be newly used from the resource management table 110 rather than finding it by calculation.

When the usage condition is satisfied, the address conversion device resource management unit 62 refers to the second channel setting table 107 and/or the first calculation method designation table 115. The address conversion device resource management unit 62 further extracts from among the extracted address conversion devices 14 the address conversion device 14#y which is provided with the first channel 21#3 designated by the same calculation method as the calculation method which is specified by the operation SA.

The operation of the operations SC and SD is similar to the operation of the operations NB and NE of FIG. 36. At the operation SE, the address conversion device resource management unit 62 sends a request acknowledgement response to the S-GW 11#b. The request acknowledgement response may include, as information which designates the selected address conversion device 14#y, an address conversion device identifier which specifies the first channel 21#3. On the other hand, at the operation SD, the address conversion device resource management unit 62 sends a request non-acknowledgement response to the S-GW 11#b.

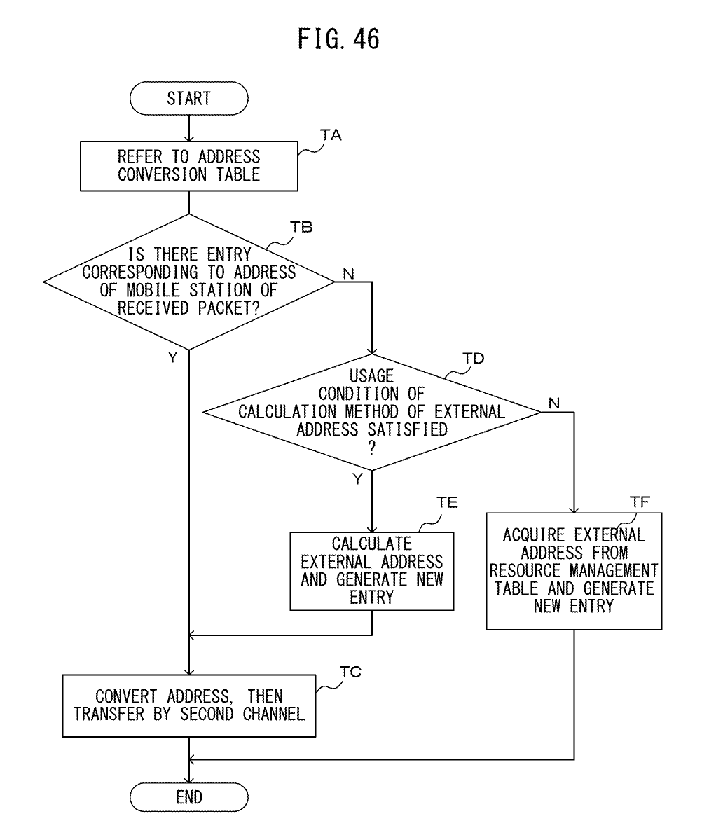

FIG. 46 is an explanatory view of a second example of the operation of the address conversion device 14 when receiving uplink packets. At the operation TA, the communication data processing unit 71 refers to the address conversion table 108 corresponding to the first channel 21#3 through which the packets are received.

At the operation TB, the communication data processing unit 71 judges if there is an entry in the address conversion table 108, which corresponds to the address of the mobile station 31#1 receiving the packets. If there is a corresponding entry in the address conversion table 108 (operation TB: Y), the operation proceeds to the operation TC. If there is no corresponding entry in the address conversion table 108 (operation TB: N), the operation proceeds to the operation TD.

At the operation TC, the communication data processing unit 71 follows the address conversion table 108 to convert the address of the mobile station 31#1 receiving packets to an external address. The communication data processing unit 71 follows the address conversion table 108 to transfer the received packets by the second channel 22#z.

At the operation TD, the conversion table management unit 72 judges if the usage condition for the method of calculation of the external address, which is determined for the first channel 21#3, is satisfied. The usage condition may, for example, be a condition which relates to the rate of use of the address conversion table 108 of the address conversion device 14#y provided with first channel 21#3. For example, the usage condition may be considered satisfied when the usage rate is less than a predetermined threshold value. When the usage condition is satisfied (operation TD: Y), the operation proceeds to the operation TE. When the usage condition is not satisfied (operation TD: N), the operation proceeds to the operation TF.

At the operation TE, the conversion table management unit 72 follows the calculation method, which is determined for the first channel 21#3, to calculate the external address corresponding to the internal address of the mobile station 31#1. The conversion table management unit 72 generates an entry which converts an address of the received packet to a calculated external address at the address conversion table 108 corresponding to the first channel 21#3. The conversion table management unit 72 registers the second channel 22#z in this entry. After that, the operation proceeds to the operation TC.

At the operation TF, the conversion table management unit 72 acquires the external address from the unused resources for the first channel 21#3 in the resource management table 110. An entry which converts the address of the received packet to an external address which is acquired from the resource management table 110, is generated in the address conversion table 108 corresponding to the first channel 21#3. The conversion table management unit 72 registers the second channel 22#z in this entry. After that, the operation proceeds to the operation TC.

In the above explanation, the views of the functional configuration of FIG. 2, FIG. 9, FIG. 11, FIG. 15, and FIG. 19 illustrate primarily the configurations relating to the functions which are explained in the present Description. The S-GW, channel control device, address conversion device, P-GW, and MME may include component elements other than the illustrated component elements. The operation which was explained with reference to FIG. 21 to FIG. 41, FIG. 45, and FIG. 46 may also be interpreted as a method including a plurality of steps. In this case, “operation” may be read as “step”.

### 4. Advantageous Effects of Embodiments

According to the present embodiments, it is possible to eliminate the processing for setting the channel of the P-GW 12 and processing for allocation of IP addresses, when transferring the additional flow by a channel routed through the P-GW 12#b other than the default P-GW 12#a. Further, by eliminating these processings, communication delays can be avoided.

Further, compared with when newly setting a channel with the P-GW 12 to S-GW 11 for the additional flow, it is possible to reduce the amount of path information which the P-GW 12 manages.

### 5. Hardware Configuration

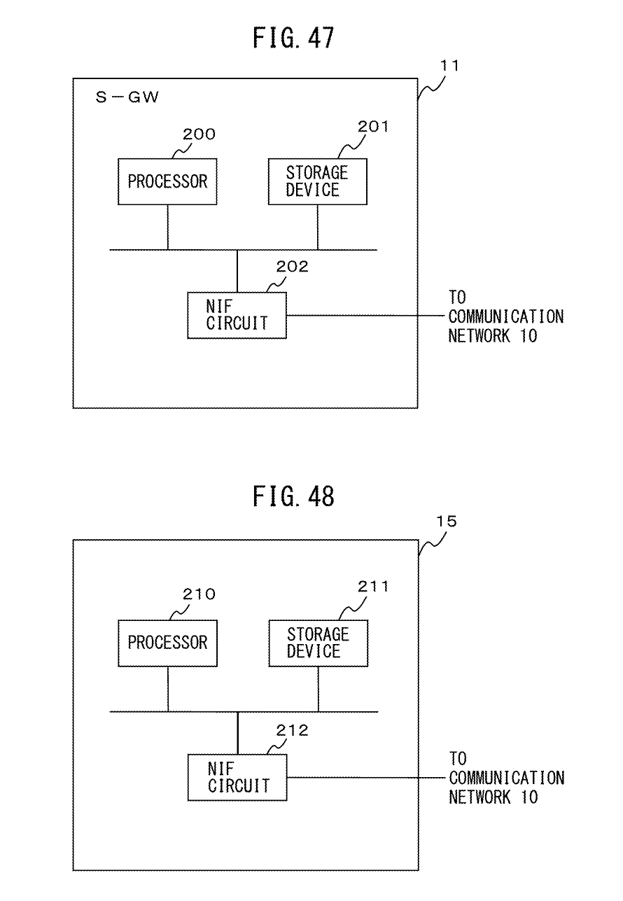

Below, examples of the hardware configurations of the component elements of the communication system 1, will be explained. FIG. 47 is an explanatory view of one example of the hardware configuration of the S-GW 11. The S-GW 11 is comprised of a processor 200, storage device 201, and network interface circuit 202. In the following explanation and attached drawings, “network interface” will sometimes be indicated as “NIF”.

The storage device 201 may include a device for storing computer programs or data such as a nonvolatile memory, read only memory (ROM), random access memory (RAM), flash memory, etc. The processor 200 controls the operation of the S-GW 11 in accordance with a computer program which is stored in the storage device 201. The NIF circuit 202 is comprised of an electronic circuit which performs processing of the physical layer, data link layer, and network layer for communication through a fixed communication line.

The above operation of the network communication unit 50 which is illustrated in FIG. 2 may be performed by the NIF circuit 202. The above operation of the communication data processing unit 51, bearer control unit 52, core network service control unit 53, replacement/new channel setting management unit 54, and address conversion service control unit 55 may be performed by the processor 200.

FIG. 48 is an explanatory view of one example of the hardware configuration of the channel control device 15. The channel control device 15 is comprised of a processor 210, storage device 211, and NIF circuit 212.

The storage device 211 may include a device for storing computer programs or data, such as a nonvolatile memory, read only memory, random access memory, flash memory, etc. The processor 210 controls the operation of the channel control device 15 in accordance with a computer program which is stored in the storage device 211. The NIF circuit 212 comprises an electronic circuit which performs the processing of the physical layer, data link layer, and network layer for communication through a fixed communication line.

The above operation of the network communication unit 60 which is illustrated in FIG. 9 may be performed by the NIF circuit 212. The above operation of the communication setting signaling processing unit 61 and address conversion device resource management unit 62 may be performed by the processor 210.

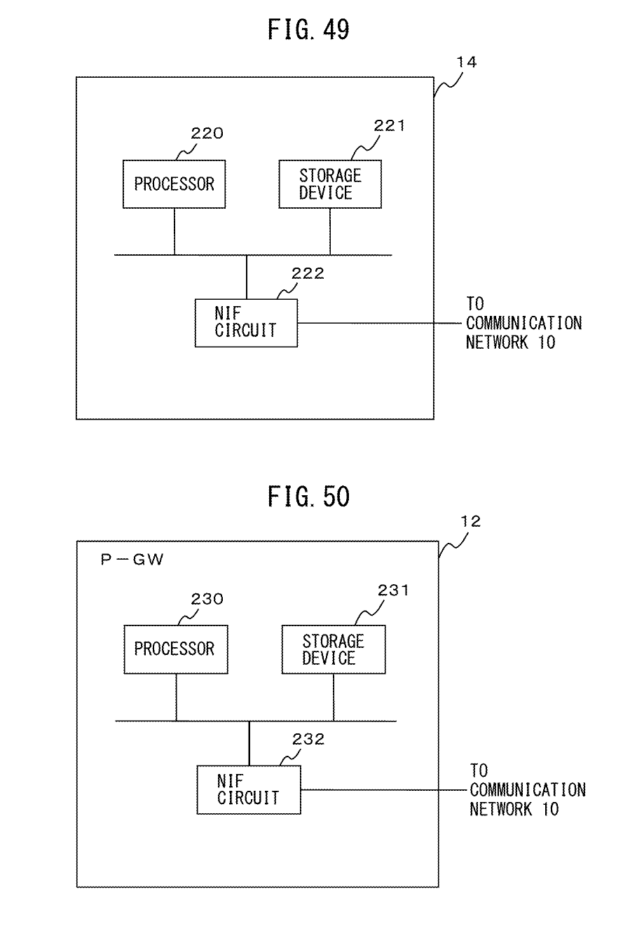

FIG. 49 is an explanatory view of one example of the hardware configuration of the address conversion device 14. The address conversion device 14 comprises a processor 220, storage device 221, and NIF circuit 222.

The storage device 221 may include a device for storing computer programs or data, such as a nonvolatile memory, read only memory, random access memory, flash memory, etc. The processor 220 controls the operation of the address conversion device 14 in accordance with a computer program which is stored in the storage device 221. The NIF circuit 222 comprises an electronic circuit which performs the processing of the physical layer, data link layer, and network layer for communication through a fixed communication line.

The above operation of the network communication unit 70 which is illustrated in FIG. 11 may be performed by the NIF circuit 222. The above operation of the communication data processing unit 71, conversion table management unit 72, and address conversion service control unit 75 may be performed by the processor 220.

FIG. 50 is an explanatory view of one example of the hardware configuration of the P-GW 12. The P-GW 12 is comprised of a processor 230, storage device 231, and NIF circuit 232.

The storage device 231 may include a device for storing computer programs or data, such as a nonvolatile memory, read only memory, random access memory, flash memory, etc. The processor 230 controls the operation of the P-GW 12 in accordance with a computer program which is stored in the storage device 231. The NIF circuit 232 comprises an electronic circuit which performs the processing of the physical layer, data link layer, and network layer for communication through a fixed communication line.

The above operation of the network communication unit 80 which is illustrated in FIG. 15 may be performed by the NIF circuit 232. The above operation of the communication data processing unit 81, bearer control unit 82, core network service control unit 83, flow management unit 84, and core network address conversion mechanism path management unit 85 may be performed by the processor 230.

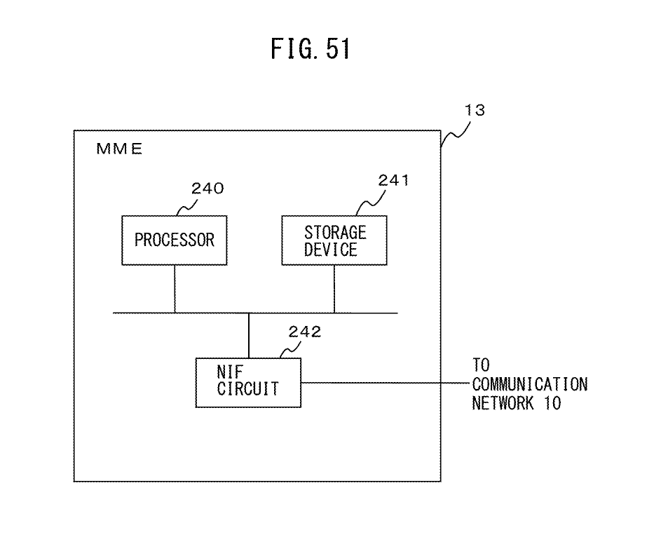

FIG. 51 is an explanatory view of one example of the hardware configuration of an MME 13. An MME 13 comprises a processor 240, storage device 241, and NIF circuit 242.

The storage device 241 may include devices for storing computer programs or data, such as a nonvolatile memory, read only memory, random access memory, flash memory, etc. The processor 240 controls the operation of the MME 13 in accordance with a computer program which is stored in the storage device 241. The NIF circuit 242 comprises an electronic circuit which performs the processing of the physical layer, data link layer, and network layer for communication through a fixed communication line.

The above operation of the network communication unit 90 which is illustrated in FIG. 19 may be performed by the NIF circuit 232. The above operation of the communication data processing unit 91, bearer control unit 92, wireless network service control unit 93, core network service control unit 94, and address conversion service control unit 95 may be performed by the processor 240.

Note that, the hardware configuration which is illustrated in FIG. 47 to FIG. 51 is only an illustration for explaining the embodiment. So long as performing the above operation, the S-GW, channel control device, address conversion device, P-GW, and MME, which are described in the present Description, may be realized by employing any other hardware configuration as well.

### 6. Other Network Configuration

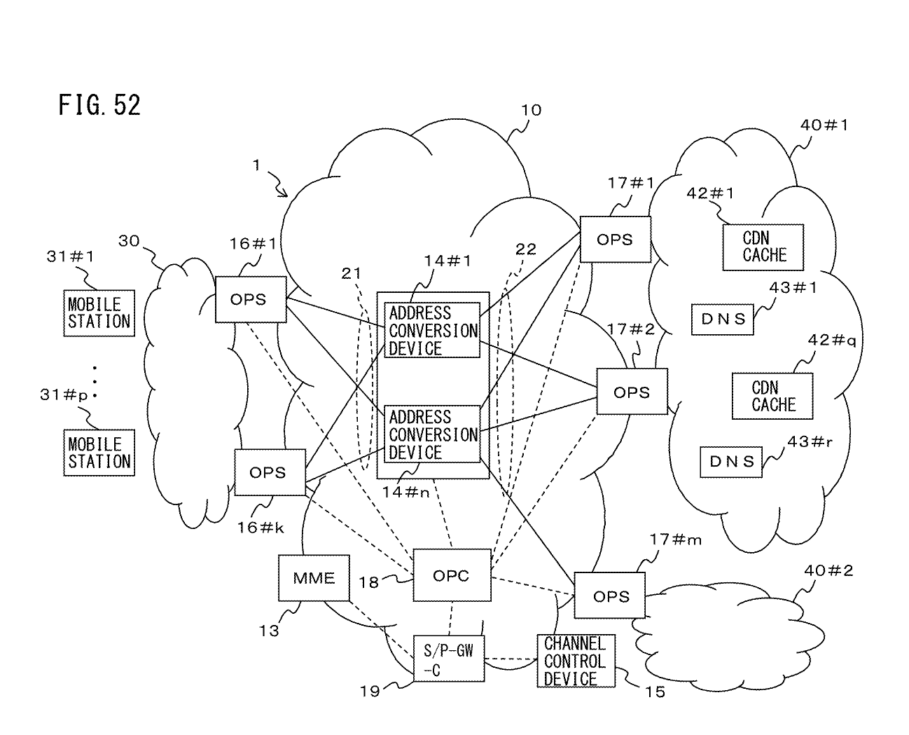

FIG. 52 is an explanatory view of a second example of the configuration of a communication system. The communication network 10 includes a predetermined control device, which calculates the path and defines the processing of the received packets, and a switch device which transfers the packets according to the control device. One example of such a control device is the OPC (open flow controller) which performs open flow protocol being standardized by the ONF (Open Networking Foundation). One example of the switch device is an OPS (open flow switch) which performs open flow protocol.

In the following explanation, the illustration of the case where the communication network 10 is a network over which packets are transferred by an OPC and OPS, is used. However, this illustration does not mean that the communication system, which is described in the present Description, is applied limited to only a communication system based on the openflow protocol. The communication system, which is described in the present Description, can be broadly applied to systems where switch devices which are provided in the communication network and which transfer packets operate in accordance with instructions of the control devices which define the path calculation and processing of the received packets.

The communication network 10 is provided with OPS 16#1 to 16#k as node devices which connect the wireless access network 30 and the communication network 10. The communication network 10 is provided with OPS 17#1 to 17#m as node devices which connect the external network 40#1, 40#2 . . . and communication network 10. The communication network 10 is provided with the OPC 18.

Note that, in the following explanation, the OPS's 16#1 to 16#k will sometimes be referred to all together as the “OPS's 16”. Further, the OPS's 17#1 to 17#k will sometimes be referred to all together as the “OPS's 17”.

The communication network 10 is provided with a gateway control plane processing apparatus 19. In the following explanation and attached figures, the gateway control plane processing apparatus will be indicated as “S/P-GW-C”. The S/P-GW-C 19 sends and receives signals with the MME 13 and channel control device 15 and performs processing of the control planes of the S-GW and P-GW which set the control tables used for packet transfer.

The S/P-GW-C 19 performs an operation similar to the processing for searching for a path of the replacement/new channel setting management unit 54 of the S-GW 11 of FIG. 2 so as to perform processing for searching for a path between the OPS 16 and CDN cache server 42. If an OPS 16 receives from a mobile station 31 a DNS request inquiring about the address of the CDN cache server 42, it transfers the DNS request to the S/P-GW-C 19.

The S/P-GW-C 19 transfers the DNS request by a path routed through an OPS 17, other than the OPS through which the default channel is routed, to thereby search for a new channel for routing the additional flow.

The S/P-GW-C 19 sets the control table for use for transfer of packets of the OPS's 16 and 17 through the OPC 18. The OPS's 16 and 17 refer to the header information of the physical layer, data link layer, network layer, and transport layer of the received packets, and select the destination route in accordance with the control table which the OPC 18 sets.

For example, the OPS's 16 may also hold the branched flow processing table 103 of FIG. 5, the integrated flow processing table 104 of FIG. 6, and the destination designation table 105 of FIG. 7. The branched flow processing table 103, integrated flow processing table 104, and destination designation table 105 are set through the OPC 18 by the S/P-GW-C 19.

For example, the first channel setting table 101 of FIG. 3 and the address conversion device table 106 of FIG. 8 are held at the S/P-GW-C 19.

Further, for example, the OPS's 17 may hold the downlink transfer table 111 of FIG. 16 and the uplink transfer table 112 of FIG. 17. The downlink transfer table 111 and uplink transfer table 112 are set in the S/P-GW-C 19 through the OPC 18.

For example, the third channel setting table 113 of the FIG. 18 is held at the S/P-GW-C 19.

In the new communication setting operation which sets a first channel 21 and second channel for a new additional flow, the S/P-GW-C 19 performs the processing for setting the new channel and sends and receives signals with the MME 13 and channel control device 15, as explained with reference to FIGS. 23 and 24. The S/P-GW-C 19 sets the branched flow processing table 103, integrated flow processing table 104, and destination designation table 105 of the OPS 16, in accordance with the signal which the S/P-GW-C 19 receives from the channel control device 15.

Due to HO of the mobile station 31, in the channel change operation, the MME 13 transmits an HO procedure message explained with reference to FIG. 31 to the S/P-GW-C 19. The channel between the OPS 16 and base station, which is constructed and released by the HO procedure, is set at the OPS 16 which holds the channel from the S/P-GW-C 19 through the OPC 18.

The S/P-GW-C 19 sends and receives signals with the MME 13 and channel control device 15 in the operation of the S-GW 11 which was explained with reference to FIG. 32 and FIG. 35. The S/P-GW-C 19 sets the branched flow processing table 103, integrated flow processing table 104, and destination designation table 105 of the OPS's 16, in accordance with the signal which the S/P-GW-C 19 received from the channel control device 15.

The S/P-GW-C 19 sends and receives signals with the channel control device 15 in the operation of the P-GW 12 which was explained with reference to FIG. 38. The S/P-GW-C 19 sets the downlink transfer table 111 of the OPS's 17 in accordance with the signal which the S/P-GW-C 19 received from the channel control device 15.

In the operation of the P-GW 12 which was explained with reference to FIG. 39, when there is no entry in the uplink transfer table 112 corresponding to the uplink received packets, the OPS's 17 transfer the received packets to the OPC 18 in accordance with the open flow protocol. The OPS 18 notifies that packet information to the S/P-GW-C 19.

The S/P-GW-C 19 uses the header information and the third channel setting table 113 to determine the second channel 22 of the downlink direction of the destination of the downlink additional flow. The S/P-GW-C 19 instructs to the OPS 17 the setting of the downlink transfer table 111, which designates the determined second channel 22 as the destination of the downlink additional flow.

According to the present embodiments, route control via the address conversion device 14 and route control from other base station devices to the P-GW can be processed integrally by the same protocol, and management of the communication system 1 becomes easy.

All examples and conditional language recited hereinafter are intended for pedagogical purposes to aid the reader in understanding the principles of the invention and the concepts contributed by the inventor to furthering the art and are to be construed as being without limitation to such specifically recited examples and conditions. Nor does the organization of such examples in the specification relate to a showing of the superiority and inferiority of the invention. Although the embodiments of the present inventions have been described in detail, it should be understood that various changes, substitutions, and alterations could be made hereto without departing from the spirit and scope of the invention.

### REFERENCE SIGNS LIST

1. communication system
11, 11#1 to 11#k. S-GW's
12, 12#1 to 12#m. P-GW's
13. MME
14, 14#1 to 14#n. address conversion devices
15. channel control device
16, 16#1 to 16#k, 17, 17#1 to 17#m. OPS's
18. OPC
19. S/P-GW-C
21. first channel
22. second channel
31, 31#1 to 31#p. mobile stations

What is claimed is:

1. A channel control device comprising:
a setting storage which stores settings for combining a plurality of first channels and a plurality of second channels, where the first channels are set between a plurality of first node devices and a plurality of address conversion devices of a second network, the first node devices connect a first network, in which a base station device is provided, to said second network, and said plurality of second channels are set between a plurality of second node devices and said plurality of address conversion devices, the second node devices connect a third network, different from said first network and said second network, to said second network; and
an address conversion device selector which selects any of said plurality of address conversion devices, where the address conversion devices act as a relay between any of said plurality of first node devices and any of said plurality of second node devices routed through any of said plurality of first channels and any of said plurality of second channels.

2. The channel control device according to claim 1, further comprising
an address information acquisition circuitry which acquires address information of a mobile station device assigned by said first address conversion device, when transferring packets of said mobile station device, which communicates through a first address conversion device among said plurality of address conversion devices, through a second address conversion device, other than the first address conversion device among said plurality of address conversion devices and
an address information transmitter which transmits said address information to said second address conversion device.

3. The channel control device according to claim 1, further comprising
a calculation method storage which stores address calculation methods which are linked with said first channels and
a calculation method specification circuit which specifies an address calculation method which is linked with any of the channels among said plurality of first channels, for communication of a mobile station device between a first address conversion device, among said plurality of address conversion devices, and any of said plurality of first node devices among said plurality of first channels,
where, said address conversion device selector selects, from said plurality of address conversion devices, a second address conversion device, other than said first address conversion device, at which a channel, other than said any channel among said plurality of first channels, is set and linked to the same calculation method as the specified address calculation method.

4. The channel control device according to claim 3, further comprising
a usage condition storage which stores a usage condition for using said address calculation method, when determining of said second address,
where, when said usage condition is satisfied, said address conversion device selector selects, from said plurality of address conversion devices, a second address conversion device, other than said first address conversion device, where a channel, other than said any channel among said plurality of first channels, is set to said second address conversion device, and the set channel is linked to the same calculation method as the specified address calculation method.

5. The channel control device according to claim 1, wherein said address conversion device selector selects an address conversion device from said plurality of address conversion devices, based on any of a transfer delay between said any of said plurality of first node devices and address conversion devices, loads of the address conversion devices, and numbers of flows held by the address conversion devices.

6. An address conversion device comprising:
a transfer circuit which transfers packets between a plurality of first channels and a plurality of second channels, the first channels are preset between a plurality of first node devices and said address conversion device, said first node devices connect a first network, in which a base station device is provided, to a second network in which said address conversion devices are provided, and said plurality of second channels are set between a plurality of second node devices and said plurality of address conversion devices, said second node devices connect a third network, different from said first network and said second network, to said second network;
a conversion information storage which stores, for each of said plurality of first channels, conversion information which links a first address of a mobile station device and a second address on said third network, said mobile station device transmits packets through said plurality of first channels;
a detector which detects an entry of a source address from said conversion information of said first channel, other than said any channel, when there is no entry of said source address of packets, which are received through any channel among said plurality of first channels, in said conversion information of said any channel, where said first channels receive packets which are transferred from any of said plurality of second node devices which transmit packets transferred to said any channel; and
a conversion information update circuit which moves said detected entry to said conversion information of said any channel.

7. The address conversion device according to claim 6 further comprising
a calculation method storage which stores address calculation methods which are linked to said first channels and
an address calculation circuit which calculates a second address which is linked to said first address of said mobile station device by said conversion information in accordance with said calculation method.

8. A communication system comprising:
a plurality of first node devices which connect a first network, to which a base station device is provided, to a second network,
a plurality of second node devices which connect a third network, different from said second network, to said second network,
a plurality of address conversion devices which are provided to said second network,
a plurality of first channels which are set between said plurality of first node devices and said plurality of address conversion devices,
a plurality of second channels which are set between said plurality of second node devices and said plurality of address conversion devices, and
a channel control device which selects any of plurality of address conversion devices, where said address conversion devices act as a relay between any of said plurality of first node devices and any of said plurality of second node devices through any of said plurality of first channels and any of said plurality of second channels.

9. A channel setting method comprising:
setting, in advance, settings which combine a plurality of first channels and a plurality of second channels, where the first channels are set between a plurality of first node devices and a plurality of address conversion devices of a second network, the first node devices connect a first network, in which a base station device is provided, to said second network, and said plurality of second channels are set between a plurality of second node devices and said plurality of address conversion devices, the second node devices connect a third network, different from said first network and said second network, to said second network; and
selecting any of said plurality of address conversion devices, where the address conversion devices act as a relay between any of said plurality of first node devices and any of said plurality of second node devices routed through any of said plurality of first channels and any of said plurality of second channels.
